(19) United States
(12) Patent Application Publication
(10) Pub. No.: US 2016/0000127 A1
(43) Pub. Date: Jan. 7, 2016

(54) MANGO FLAVOR COMPOSITIONS

(71) Applicant: MARS, INCORPORATED, Mclean,, VA (US)

(72) Inventors: John Didzbalis, Cranford, NJ (US); John P. Munafo, Hackettstown, NJ (US)

(73) Assignee: MARS, INCORPORATED, Mclean, VA (US)

(21) Appl. No.: 14/769,755

(22) PCT Filed: Feb. 20, 2014
(86) PCT No.: PCT/US2014/017354

§ 371 Date: Aug. 21, 2015

Related U.S. Application Data
(60) Provisional application No. 61/767,539, filed on Feb. 21, 2013.

(51) Int. Cl. A23L 1/235; A23L 1/226; A23L 1/222

(52) U.S. Cl. CPC A23L 1/235; A23L 1/222; A23L 1/2265; A23L 1/22671; A23L 1/22628; A23L 1/22614; A23L 1/22678; A23V 2002/00; A23G 4/06

(57) ABSTRACT

The presently disclosed subject matter is directed to a flavor system, where by specific base flavors are created and manipulated with specific cultivar character components to establish a spectrum of flavors within a target flavor. Specifically, the presently disclosed subject matter discloses mango base flavor compositions containing (a) a furanone compound, (b) an ester compound, (c) an aldehyde compound, (d) a hydrocarbon compound, and (e) a lactone compound. The base flavor compositions can be used alone or in combination with specific cultivar character components to meet flavor preferences across different regions.

### CROSS-REFERENCE TO RELATED APPLICATION

This application claims priority to U.S. Application Ser. No. 61/767,539 filed Feb. 21, 2013, which is incorporated by reference in its entirety herein.

### FIELD OF THE INVENTION

The presently disclosed subject matter is directed to a flavor system for mango-based flavor compositions and methods for making such compositions.

### BACKGROUND OF THE INVENTION

Current flavor systems for mango flavorings do not adequately capture the distinct, true-fruit flavor of unique cultivars. Across different cultures and geographies, local taste preferences are variable based on locally grown food products. For example, fruits cultivated in one region will carry different flavor notes as compared to the same fruit grown in a different region. The fruit compound profiles will vary based on cultivar, geographic variation, maturity, and processing. Certain products can exhibit various degrees of sweetness or sourness, depending on sugar and acid content. Thus, the individual preferences for specific flavors are not consistent around the world.

There are numerous challenges in identifying the chemical nature of specific flavor systems, but moreso in the ability to control modification of specific flavors. Such challenges include complex mechanisms behind flavor development, quantification of flavor characterization, and accurate determinations of correlation between flavor and chemistry.

U.S. Pat. No. 5,021,402 (to Firmenich SA) disclosed a mango-type flavor composition containing various ingredients in combination for the creation of a “base” flavor composition. Various ether compounds were individually added to the base flavor composition to modify the mango flavor.

U.S. Pat. No. 6,025,005 (to Dragoco Gerberding & Co. AG) disclosed a mango flavor composition, whereby the aroma of a basic composition was influenced by the addition of a thioacidic acid. According to the disclosure, the addition of the acid affected the composition in a herbal-fruitier manner.

U.S. Pat. No. 6,072,077 (to Haarmann & Reimer, GmbH) disclosed specific novel 5-Z-octenyl esters capable of mango aromas. Such compounds were disclosed to be capable of intensifying and rounding mango flavors and aromas upon addition to food and drink products.

While thousands of flavor chemicals are known, and it is known to combine flavor chemicals to create flavor systems, to date, true-fruit mango cultivar flavors have yet to be identified. As such, currently available mango flavors do not capture true, the fruit cultivar flavor subtleties. Thus, there remains a need in the art for a flavor system that is able to customize global products to meet local acceptance standards across various geographies.

By accurately tailoring mango flavors to cultivars beloved by consumers in specific geographies, the presently disclosed subject matter addresses this need. In the presently disclosed subject matter, a base flavor that is common to a range of mango cultivars has been identified, whereby specific cultivar components can be added to the base flavor to create the flavor for the desired cultivar.

### SUMMARY OF THE INVENTION

The presently disclosed subject matter is directed to flavor compositions and methods for making and modifying such compositions across a variety of food compositions. By combining specific compounds characteristic of flavors of certain regions, the compositions are made to suit the tastes of local preferences. Specifically, the presently disclosed subject matter is directed to mango flavored compositions.

In one aspect of the presently disclosed subject matter, there is a flavor composition comprising a furanone compound, an ester compound, an aldehyde compound, a hydrocarbon compound, and a lactone compound. The furanone composition is selected from the group consisting of 4-methoxy-2,5-dimethyl-3(2H)-furanone, 4-hydroxy-2,5-dimethyl-3(2H)-furanone, 3-hydroxy-4,5-dimethyl-2(5H)-furanone, and combinations thereof. The furanone compound is present at an amount of from about 0.6% to about 0.8% w/w by weight of the flavor composition, preferably from about 0.7% to about 0.8% w/w by weight of the composition. The ester compound is selected from the group consisting of ethyl-2-methypropanote, ethyl butanoate, ethyl-2-methybutanoate, ethyl-3-methylbutanoate, and combinations thereof. The ester compound is present at an amount from about 0.02% to about 0.04% w/w by weight of the flavor composition, preferably from about 0.03% to about 0.04% w/w by weight of the composition. The aldehyde compound is selected from the group consisting of (E)-3-hexenal, (Z)-3-hexenal, (E)-2-nonenal, (E,Z)-2,6-nonadienal, and combinations thereof. The aldehyde compound is present at an amount of from about 0.02% to about 0.04% w/w by weight of the flavor composition, preferably from about 0.03% to about 0.04% w/w by weight of the composition. The hydrocarbon compound is selected from the group consisting of myrcene, β-(Z)-ocimene, β-(E)-ocimene, 1-(E,Z)-undecatriene, 1,3,5,8-undecatetraene, and combinations thereof. The hydrocarbon compound is present at an amount of from about 0.01% to about 0.02% w/w by weight of the flavor composition, preferably from about 0.015% to about 0.02% w/w by weight of the composition. The lactone compound is selected from the group consisting of γ-octalactone, γ-decalactone, δ-decalactone, and combinations thereof. The lactone compound is present at an amount of from about 0.01% to about 0.02% w/w by weight of the flavor composition, preferably from about 0.015% to about 0.02% w/w by weight of the composition. In one embodiment, the flavor composition is natural.

The flavor composition further comprises a cultivar component. The cultivar component is present in an amount of from about 5% to about 30% w/w by weight of the flavor composition, preferably from about 10% to about 25% w/w by weight of the flavor composition. In one embodiment, the cultivar component is fruity. The fruity component is selected from the group consisting of a first fruity compound, a second fruity compound, and combinations thereof. The first fruity compound is selected from the group consisting of ethyl-2-methypropanoate, ethyl butanoate, ethyl-2-methybutanoate, ethyl-3-methylbutanoate, and combinations thereof. The second fruity compound is selected from the group consisting of 2-acetyl-1-pyrroline, 1-(E,Z)-undecatriene, 3-(methylthio)-propanal, phenylethyl alcohol, γ-octalactone, and combinations thereof.

In one embodiment, the cultivar component is a terpene-like component. The terpene-like component is selected from the group consisting of a first terpene-like compound, a second terpene-like compound, and combinations thereof. The first terpene-like compound is selected from the group consisting of myrcene, β-(Z)-ocimene, β-(E)-ocimene, and combinations thereof. The second terpene-like compound is selected from the group consisting of ethyl butanoate, 2-acetyl-1-pyrroline, 1-(E,Z)-undecatrine, 1,3,5,8-undecatetraene, γ-octalactone, β-ionone, and combinations thereof.

In one embodiment, the cultivar component is a dairy component. The dairy component is selected from the group consisting of a first dairy compound, a second dairy compound, and combinations thereof. The first dairy compound is selected from the group consisting of 2,3-butandione, butanoic acid, 2-methylbutanoic acid, 3-methylbutanoic acid, and combinations thereof. The second dairy compound is selected from the group consisting of ethyl butanoate, (E)-3-hexenal, 2-acetyl-1-pyrroline, (E)-2-nonenal, (E,Z)-2,6-nonedienal, 3-methyl-2,4-nonandione, γ-octalactone, and combinations thereof.

In one embodiment, the cultivar component is a berry component. The berry component is selected from the group consisting of a first berry compound, a second berry compound, and combinations thereof. The first berry compound is selected from the group consisting of dihydro-β-ionone, β-ionone, and combinations thereof. The second berry compound is selected from the group consisting of 1,3,5,8-undecatetraene, 4-methoxy-2,5-dimethyl-3(2H)-furanone, γ-octalactone, and combinations thereof.

In one embodiment, the cultivar component is a tropical component. The tropical component is selected from the group consisting of a first tropical compound, a second tropical compound, and combinations thereof. The first tropical compound is selected from the group consisting of 4-mentha-8-thiol-3-one, 4-mercapto-4-methyl-2-pentanone, and combinations thereof. The second tropical compound is selected from the group consisting of myrcene, 2-acetyl-1-pyrroline, γ-octalactone, and combinations thereof.

In one aspect of the presently disclosed subject matter, there is a food product comprising the flavor composition of the presently disclosed subject matter. The furanone compound of the flavor composition is present in the food product composition at an amount of from about 1.1 ppb to about 15 ppb preferably from about 5 ppb to about 10 ppb in the composition. The ester compound of the flavor composition is present in the food product composition at an amount of from about 0.063 ppb to about 5 ppb preferably from about 0.1 ppb to about 3 ppb in the composition. The aldehyde compound of the flavor composition is present in the food product composition at an amount of from about 0.0091 ppb to about 5 ppb preferably from about 0.1 ppb to about 5 ppb in the composition. The hydrocarbon compound of the flavor composition is present in the food product composition at an amount of from about 0.003 ppb to about 5 ppb, preferably from about 0.1 ppb to about 3 ppb in the composition. The lactone compound of the flavor composition is present in the food product composition at an amount of from about 2.4 ppb to about 150 ppb, preferably from about 50 ppb to about 100 ppb in the composition.

For food product compositions with flavor composition that include cultivar components, the cultivar component can be a fruity component, which is present in the food product composition at an amount of from about 0.063 ppb to about 5 ppb, preferably from about 0.1 ppb to about 3 ppb in the composition. In other embodiments, the cultivar component can be a terpene-like component, which is present in the food product composition at an amount of from about 4.9 ppb to about 100 ppb, preferably from about 10 ppb to about 75 ppb in the composition. In other embodiments, the cultivar component is a dairy component, which is present in the food product composition at an amount of from about 1200 ppb to about 15,000 ppb, preferably from about 1,500 ppb to about 10,000 ppb in the composition. In other embodiments, the cultivar component is a berry component, which is present in the food product composition at an amount of from about 8.4 ppb to about 150 ppb, preferably from about 25 ppb to about 125 ppb in the composition. In still other embodiments, the cultivar component is a tropical component, which is present in the food product composition at an amount of from about 0.0001 ppb to about 1 ppb preferably from about 0.005 ppb to about 0.5 ppb in the composition.

In one aspect of the presently disclosed subject matter, there is a method of making a cultivar mango flavor composition, which comprises providing a base flavor composition, providing a cultivar component, and combining the base flavor composition with the cultivar component. The base flavor composition comprises a furanone compound, an ester compound, an aldehyde compound, a hydrocarbon compound, and a lactone compound. The cultivar component is selected from the group consisting of a fruity component, a terpene-like component, a dairy component, a berry component, and a tropical component

In one aspect of the presently disclosed subject matter, there is a method of making a mango flavor composition, which comprises providing (i) a furanone compound, (ii) an ester compound, (iii) an aldehyde compound, (iv) a hydrocarbon compound, (v) a lactone compound, and combining compounds (i) to (v).

In one aspect of the presently disclosed subject matter, there is a method of making a mango-flavored food product, which comprises admixing the food product with a mango flavor composition. The mango flavor composition comprises a furanone compound, an ester compound, an aldehyde compound, a hydrocarbon compound, and a lactone compound. The method further comprises admixing the food product with a cultivar component. The cultivar component is selected from the group consisting of a fruity component, a terpene-like component, a dairy component, a berry component, and a tropical component.

The compositions of the presently disclosed subject matter can be modified to provide for any number of improved flavor profiles, which closely mimic those products otherwise formed after long aging processes and which provide for enhanced desirable food additions to a wide variety of options. The flavors of the presently disclosed subject matter can be used throughout the entire food industry, for example, for the flavoring or enhanced flavoring of confections, snack food products, bakery products, salad dressing, and pastas among others. The concentration of such flavors comprises a wide array of levels and ranges, as the intensity will depend on the finished food products as well as personal preferences.

The foregoing has outlined rather broadly the features and technical advantages of the presently disclosed subject matter in order that the detailed description of the invention that follows can be better understood. Additional features and advantages of the invention will be described hereinafter which form the subject of the claims of the invention. It should be appreciated by those skilled in the art that the conception and specific embodiment disclosed can be readily utilized as a basis for modifying or designing other structures for carrying out the same purposes of the presently disclosed subject matter. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description.

### DESCRIPTION OF THE FIGURES

FIG. 1 provides a sensory profile of fresh mango flesh obtained from five mango cultivars. The profile was established by panelists who rated the specific descriptors based on a point scale.

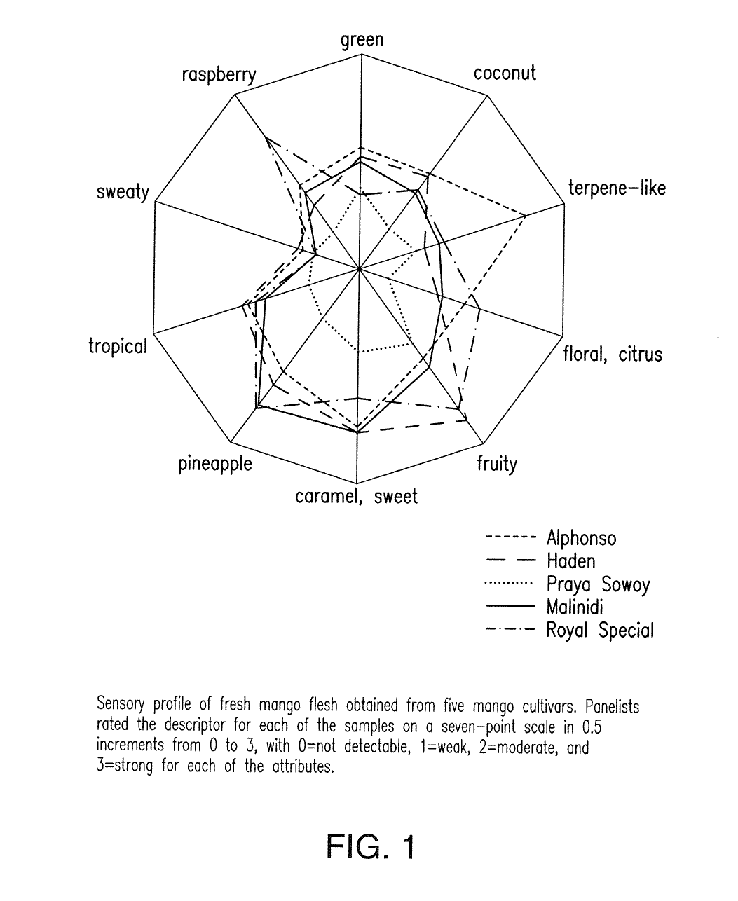

### DETAILED DESCRIPTION OF THE INVENTION

To date, there remains a need for a method of manufacturing flavoring compositions that are more representative of the characteristic flavors associated with well-known food products, and therefore, more authentic. The present formulations provide authentic alternatives for various flavorings, including that of mango flavors. Different regions encompass different variations in particular food products. The presently disclosed subject matter allows for specifying particular notes in the flavoring compositions and methods of their preparation to reflect the taste and aroma sensations associated with these products.

For clarity and not by way of limitation, this detailed description is divided into the following sub-portions:

I. Definitions;

II. Mango flavor components;

III. AEDA methodology;

IV. Delivery Systems; and

V. End Product Systems.

### I. DEFINITIONS

The terms used in this specification generally have their ordinary meanings in the art, within the context of this invention and in the specific context where each term is used. Certain terms are discussed below, or elsewhere in the specification, to provide additional guidance to the practitioner in describing the compositions and methods of the invention and how to make and use them.

As used herein, the use of the word “a” or “an” when used in conjunction with the term “comprising” in the claims and/or the specification can mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

As used herein, “flavor” shall include odor and/or taste. The terms “flavor” and “aroma” are synonymous and are used interchangeably. The flavor composition can be selected from a liquid, dry powder, spray, paste, suspension and any combination thereof. The flavor can be a natural composition, an artificial composition or any combination thereof.

As used herein, “ppb” means parts-per-billion and is a weight relative parameter. A part-per-billion is a nanogram per gram, such that a component that is present at 10 ppb is present at 10 nanograms of the specific component per 1 gram of the aggregate mixture.

As used herein, “ppm” means parts-per-million and is a weight relative parameter. A part-per-million is a microgram per gram, such that a component that is present at 10 ppm is present at 10 micrograms of the specific component per 1 gram of the aggregate mixture.

As used herein, “food product” or “food product composition” includes ingestible products including but not limited to human foods, animal or pet foods, pharmaceutical products, and consumer products.

As used herein “admixing the product or food product with a flavor composition” refers to the process where the flavor is mixed with or added to the completed product or mixed with some or all of the components of the product during product formation or some combination of these steps. When used in the context of admixing the term “product” refers to the product or any of its components. This admixing step can include a process selected from the step of adding the flavor to the product, spraying the flavor on the product, coating the flavor on the product, suspending the product in the flavor, painting the flavor on the product, pasting the flavor on the product, encapsulating the product with the flavor, mixing the flavor with the product and any combination thereof. The flavor composition can be a liquid, dry powder, spray, paste, suspension and any combination thereof.

As used herein, “potency” of a compound refers to the relationship between an amount of a flavor compound needed in an edible composition to provide a recognizable flavor note as compared to a standard reference. The potency can be measured by sensory testing. The more potent a compound is, the lower the use level in edible compositions.

As used herein, “standard potency” is used to describe a compound whose use level is similar to the amount of a flavor compound known to be a reference compound for a particular flavor note. A “higher potency” is used to describe one order of magnitude higher over the standard potency. Additionally, “highest potency” is used to describe two orders of magnitude over the standard potency. Likewise, a “lower potency” is used do describe one order of magnitude less than the standard potency; and “lowest potency” is used to describe two orders of magnitude less than the standard potency.

As used herein, “threshold level” relates to an amount at which a flavor is detected or recognized. A detection level is the point at which a taste is detected as compared to a control such as water. A recognition level is the point at which a specific taste is recognizable.

As used herein, an “equivalent organoleptic effect” refers to a potency equivalent perception factor, akin to an effective amount of compound that achieves a specific targeted flavor.

### II. Mango Flavor Components

In the presently disclosed subject matter, the compositions start with a combination of odorant compounds to establish a base flavor. Specific cultivar compounds are then added to the composition to enhance specific flavor preferences.

### A. Base Flavor Compounds

The base flavoring composition of the presently disclosed subject matter comprises the following odorant compounds:

(a) a furanone compound,

(b) an ester compound,

(c) an aldehyde compound,

(d) a hydrocarbon compound, and

(e) a lactone compound.

The amount of each compound in the flavoring composition varies depending on the potencies of each compound. Some compounds are primary compounds, which contribute the most flavor, while other compounds are secondary or tertiary compounds, which contribute less to the flavoring composition. The amount of each compound employed in the base flavoring composition is an effective amount to provide a flavoring composition that exhibits a sensory effect. When a compound is a primary compound and thus provides a larger contribution to the character of the flavoring composition, the amount of the primary compound will increase when its potency is lower, and the amount of the primary compound will decrease when its potency is higher. The contribution and potency adjustments maintain the flavoring composition's balance. With respect to the contribution to the character of the flavoring composition of the presently disclosed subject matter, the furanone compound has the most, the hydrocarbon compound has the least, and the lactone compound is more than the ester compound, which is more than the aldehyde compound.

Furanone Compounds:

Furanone compounds are known in the art to have various utilities. For example, U.S. Pat. No. 4,277,511 describes that 4-hydroxy-2,5-dimethyl-3-(2H)-furanone can be used to provide a background of sugar flavor and accentuate the feeling of the type of sweetness associated with sucrose in sweetener and flavoring compositions, and also reduces whatever very minor aftertaste effects that the sweetener and flavor compositions can have. U.S. Pat. No. 4,294,767 describes 2,5-dimethyl-4-ethylidene-dihydro-3(2H)-furanone and an odour of burnt sugar associated with it. U.S. Pat. No. 5,599,960 describes that 3,5-dimethyl-pentenyl-dihydro-2(3H)-furanone isomer mixtures can be used to contribute sweet, lactonic, coumarinic, jasmine aromas with intense green, citrusy, sweet, lactonic topnotes and bergamot peel and lemony undertones to perfume compositions, perfumed articles, colognes, deodorizing articles, deodorizing compositions and malodor maskants. U.S. Pat. No. 6,296,889 describes the use of certain furanone compounds in conjunction with 1-nonen-3-one to provide dairy and coffee aroma flavor enhancement.

The furanone compound comprised in the flavoring composition of the presently disclosed subject matter provides a sweet or sugary aroma. Examples of the furanone compound that can be used in compositions of the presently disclosed subject matter include, but are not limited to, 4-methoxy-2,5-dimethyl-3(2H)-furanone, 4-hydroxy-2,5-dimethyl-3(2H)-furanone, 3-hydroxy-4,5-dimethyl-2(5H)-furanone, 2-ethyl-4-hydroxy-5-methyl-3(2H)-furanone, and 5-ethyl-3-hydroxy-4-ethyl-2(5H)-furanone, and combinations thereof. Preferably, the furanone compound is one selected from the group consisting of 4-methoxy-2,5-dimethyl-3(2H)-furanone, 4-hydroxy-2,5-dimethyl-3(2H)-furanone, 3-hydroxy-4,5-dimethyl-2(5H)-furanone, and combinations thereof. 4-methoxy-2,5-dimethyl-3(2H)-furanone and 4-hydroxy-2,5-dimethyl-3(2H)-furanone can provide a caramel-like aroma. 3-hydroxy-4,5-dimethyl-2(5H)-furanone can provide a maple aroma. The Table below provides various non-limiting furanone groups and their respective odor quality.

TABLE 1
Furanone groups (sweet/sugary aroma)

| Odorant | Odor Quality |
|---|---|
| 4-methoxy-2,5-dimethyl-3(2H)-furanone | caramel-like |
| 4-hydroxy-2,5-dimethyl-3(2H)-furanone | caramel-like |
| 3-hydroxy-4,5-dimethyl-2(5H)-furanone* | maple, seasoning-like |

*Most potent

The amount of the furanone compound present in the flavoring composition varies depending on the potency of the compound. In one embodiment, the furanone compound is present in an amount of from about 0.6% to about 0.8% w/w by weight of the flavor composition, preferably from about 0.7% to about 0.8% w/w by weight of the composition, where the furanone compound has a standard potency.

Ester Compound:

Certain types of ester compounds are well known to be responsible for common scents, such as fruit scents. For example, ethyl (S)-(+)-2-methylbutanoate is known to have a fruity, apple-like scent. See e.g., Hauck T, et al., “Metabolism of ethyl tiglate in apple fruits leads to the formation of small amounts of (R)-ethyl 2-methylbutanoate,” Enantiomer. 2000; 5(5):505-12.

Examples of ester compounds of the presently disclosed subject matter that can be used in compositions of the presently disclosed subject matter include, but are not limited to, ethyl-2-methypropanote, ethyl butanoate, ethyl-2-methybutanoate, ethyl-3-methylbutanoate, and combinations thereof. Preferably, the furanone compound is one selected from the group consisting of ethyl-2-methypropanote, ethyl butanoate, ethyl-2-methybutanoate, ethyl-3-methylbutanoate, and combinations thereof. Ethyl-2-methypropanote, ethyl butanoate, ethyl-2-methybutanoate, and ethyl-3-methylbutanoate can provide fruity aroma, for example, mango, pineapple, banana, apple, rum, passion fruit, Samson, cedar, and pear. The Table below provides various non-limiting ester groups and their respective odor quality.

TABLE 2
Ester Group (fruity)

| odorant | odor quality |
|---|---|
| ethyl-2-methypropanoate | fruity |
| ethyl butanoate | fruity |
| ethyl-2-methybutanoate* | fruity |
| ethyl-3-methylbutanoate | fruity |

*Most potent

The ester compound comprised in the flavoring composition of the presently disclosed subject matter provides a fruity aroma. The amount of the ester compound present in the flavoring composition varies depending on the potency of the compound. In one embodiment, the ester compound is present in an amount of from about 0.02% to about 0.04% w/w by weight of the flavor composition, preferably from about 0.03% to about 0.04% w/w by weight of the composition, where the ester compound has a standard potency.

Aldehyde compound: Various aldehyde compounds are known in the art to be responsible for specific scents. For example, U.S. Pat. No. 8,268,371 describes various aldehyde compounds, the disclosure of which is incorporated herein by reference in its entirety. The Table below provides various non-limiting aldehyde groups and their respective odor quality.

TABLE 3
Aldehyde group (green aroma)

| odorant | odor quality |
|---|---|
| (E)-3-hexenal | green |
| (Z)-3-hexenal | green |
| (E)-2-nonenal | green |
| (E,Z)-2,6-nonadienal* | cucumber |

*Most potent

At least one of the aldehyde compounds (or combinations thereof) is used in the base composition. The aldehyde compound comprised in the flavoring composition of the presently disclosed subject matter provides a green aroma. The amount of the aldehyde compound present in the flavoring composition varies depending on the potency of the compound. In one embodiment, the aldehyde compound is present in an amount of from about 0.02% to about 0.04% w/w by weight of the flavor composition, preferably from about 0.03% to about 0.04% w/w by weight of the composition, where the aldehyde compound has a standard potency.

Hydrocarbon Compound:

Various hydrocarbon compounds are known in the art to be responsible for specific scents. The Table below provides various non-limiting hydrocarbon groups and their respective odor quality.

TABLE 4
Terpene-like/hydrocarbon group (herbal/piney aroma)

| odorant | odor quality |
|---|---|
| myrcene | terpene-like |
| β-(Z)-ocimene | terpene-like |
| β-(E)-ocimene | terpene-like |
| 1-(E,Z)-undecatriene* | pineapple |
| 1,3,5,8-undecatetraene | pineapple |

*Most potent

At least one of the hydrocarbon compounds (or combinations thereof) is used in the base composition. The hydrocarbon compound comprised in the flavoring composition of the presently disclosed subject matter provides an herbal and/or piney aroma. The amount of the hydrocarbon compound present in the flavoring composition varies depending on the potency of the compound. In one embodiment, the hydrocarbon compound is present in an amount of from about 0.01% to about 0.02% w/w by weight of the flavor composition, preferably from about 0.015% to about 0.02% w/w by weight of the composition, where the hydrocarbon compound has a standard potency.

Lactone Compound:

Various lactone compounds are known in the art to be responsible for specific scents. The Table below provides various non-limiting lactone groups and their respective odor quality.

TABLE 5
Lactone Group

| odorant | odor quality |
|---|---|
| γ-octalactone* | coconut |
| γ-decalactone | coconut |
| δ-decalactone | coconut |

*Most potent

At least one of the lactone compounds (or combinations thereof) is used in the base composition. The lactone compound comprised in the flavoring composition of the presently disclosed subject matter provides a coconut aroma. The amount of the lactone compound present in the flavoring composition varies depending on the potency of the compound. In one embodiment, the lactone compound is present in an amount of from about 0.01% to about 0.02% w/w by weight of the flavor composition, preferably from about 0.015% to about 0.02% w/w by weight of the composition, where the lactone compound has a standard potency.

### B. Cultivar Compounds as Flavor Modifiers

As discussed above, specific cultivar compounds or cultivar components can be added to the mango base flavor composition to create the flavor for the desired target cultivar. Various compounds or components can be used, including but not limited to, cultivars having one or more of the following aroma targets:

a. a fruity aroma,

b. a terpene-like aroma,

c. a dairy aroma,

d. a berry aroma,

e. a tropical aroma, and

f. combinations thereof.

The presently disclosed subject matter includes numerous varieties of fruit targets. For example, the different varieties of mangos that are region specific are contemplated by the presently disclosed subject matter. Non-limiting examples of mango fruit varieties include the Haden (H) cultivar, White Alphonso (WA) cultivar, Praya Sowoy (PS) cultivar, Royal Special (RS) cultivar, and Malindi (M) cultivar. Each variety differs with respect to the specific aromas that each variety contains. As such, the different aroma targets of the presently disclosed subject matter are used to arrive at the specific cultivar aromas.

A non-limiting example of a fruity aroma is reminiscent of the Haden cultivar. A non-limiting example of a terpene-like aroma is reminiscent of White Alphonso (WA) cultivar. A non-limiting example of a dairy aroma is reminiscent of Praya Sowoy (PS) cultivar. A non-limiting example of a berry aroma is reminiscent of Royal Special (RS) cultivar. A non-limiting example of a tropical aroma is reminiscent of Malindi (M) cultivar. As used herein “reminiscent” refers to those flavor blends that occupy the same sensory space when tested using sensory testing methods.

To achieve the specific cultivar aromas, various compounds are used. These compounds can include certain base flavor compounds or additional compounds not yet utilized in the base composition.

In one embodiment, the cultivar component is a fruity. The fruity component is selected from the group consisting of a first fruity compound, a second fruity compound, and combinations thereof. The first fruity compound is selected from the group consisting of ethyl-2-methypropanoate, ethyl butanoate, ethyl-2-methybutanoate, ethyl-3-methylbutanoate, and combinations thereof. The second fruity compound is selected from the group consisting of 2-acetyl-1-pyrroline, 1-(E,Z)-undecatriene, 3-(methylthio)-propanal, phenylethyl alcohol, γ-octalactone, and combinations thereof.

In one embodiment, the cultivar component is a terpene-like component. The terpene-like component is selected from the group consisting of a first terpene-like compound, a second terpene-like compound, and combinations thereof. The first terpene-like compound is selected from the group consisting of myrcene, β-(Z)-ocimene, β-(E)-ocimene, and combinations thereof. The second terpene-like compound is selected from the group consisting of ethyl butanoate, 2-acetyl-1-pyrroline, 1-(E,Z)-undecatrine, 1,3,5,8-undecatetraene, γ-octalactone, β-ionone, and combinations thereof.

In one embodiment, the cultivar component is a dairy component. The dairy component is selected from the group consisting of a first dairy compound, a second dairy compound, and combinations thereof. The first dairy compound is selected from the group consisting of 2,3-butandione, butanoic acid, 2-methylbutanoic acid, 3-methylbutanoic acid, and combinations thereof. The second dairy compound is selected from the group consisting of ethyl butanoate, (E)-3-hexenal, 2-acetyl-1-pyrroline, (E)-2-nonenal, (E,Z)-2,6-nonedienal, 3-methyl-2,4-nonandione, γ-octalactone, and combinations thereof.

In one embodiment, the cultivar component is a berry component. The berry component is selected from the group consisting of a first berry compound, a second berry compound, and combinations thereof. The first berry compound is selected from the group consisting of dihydro-β-ionone, β-ionone, and combinations thereof. The second berry compound is selected from the group consisting of 1,3,5,8-undecatetraene, 4-methoxy-2,5-dimethyl-3(2H)-furanone, γ-octalactone, and combinations thereof.

In one embodiment, the cultivar component is a tropical component. The tropical component is selected from the group consisting of a first tropical compound, a second tropical compound, and combinations thereof. The first tropical compound is selected from the group consisting of 4-mentha-8-thiol-3-one, 4-mercapto-4-methyl-2-pentanone, and combinations thereof. The second tropical compound is selected from the group consisting of myrcene, 2-acetyl-1-pyrroline, γ-octalactone, and combinations thereof.

The cultivar component is present in an amount of from about 5% to about 30% w/w by weight of the flavor composition, alternatively from about 10% to about 25% w/w by weight of the flavor composition. In the context of base compound comparisons, the cultivars are used in combination with the base composition in a ratio of base to cultivar ranging from about 70% to about 95% base and from about 30% to about 5% cultivar. Alternative ranges include a ratio of base to cultivar ranging from 75% to about 95% base and from about 25% to about 5% cultivar; from 80% to about 95% base and from about 20% to about 5% cultivar; from about 85% to about 95% base and from about 15% to about 5% cultivar; from about 90% to about 95% base and from about 10% to about 5% cultivar; from about 75% to about 90% base and from about 10% to about 25% cultivar.

Alternatively, the amount for each cultivar component ranges from about 1 ppb to about 1,000 ppm, or from about 1 ppb to about 750 ppm, from about 1 ppb to about 500 ppm, from about 1 ppb to about 250 ppm, or from about 1 ppb to about 100 ppm.

In one aspect of the presently disclosed subject matter, there is a food product comprising the flavor composition of the presently disclosed subject matter. The furanone compound of the flavor composition is present in the food product composition at an amount of from about 1.1 ppb to about 15 ppb preferably from about 5 ppb to about 10 ppb in the composition. The ester compound of the flavor composition is present in the food product composition at an amount of from about 0.063 ppb to about 5 ppb preferably from about 0.1 ppb to about 3 ppb in the composition. The aldehyde compound of the flavor composition is present in the food product composition at an amount of from about 0.0091 ppb to about 5 ppb preferably from about 0.1 ppb to about 5 ppb in the composition. The hydrocarbon compound of the flavor composition is present in the food product composition at an amount of from about 0.003 ppb to about 5 ppb, preferably from about 0.1 ppb to about 3 ppb in the composition. The lactone compound of the flavor composition is present in the food product composition at an amount of from about 2.4 ppb to about 150 ppb, preferably from about 50 ppb to about 100 ppb in the composition.

For food product compositions with flavor composition that include cultivar components, the cultivar component can be a fruity component, which is present in the food product composition at an amount of from about 0.063 ppb to about 5 ppb, preferably from about 0.1 ppb to about 3 ppb in the composition. In other embodiments, the cultivar component can be a terpene-like component, which is present in the food product composition at an amount of from about 4.9 ppb to about 100 ppb, preferably from about 10 ppb to about 75 ppb in the composition. In other embodiments, the cultivar component is a dairy component, which is present in the food product composition at an amount of from about 1200 ppb to about 15,000 ppb, preferably from about 1,500 ppb to about 10,000 ppb in the composition. In other embodiments, the cultivar component is a berry component, which is present in the food product composition at an amount of from about 8.4 ppb to about 150 ppb, preferably from about 25 ppb to about 125 ppb in the composition. In still other embodiments, the cultivar component is a tropical component, which is present in the food product composition at an amount of from about 0.0001 ppb to about 1 ppb preferably from about 0.005 ppb to about 0.5 ppb in the composition.

Various standard use levels for odorants and flavor ingredients are disclosed in G. A. Burdock, Fenaroli's Handbook of Flavor Ingredients, 6th Ed. (2009), the disclosure of which is incorporated by reference herein in its entirety. Various nonlimiting odorants from Fenaroli's Handbook are provided in the table below, which have been excerpted from the Handbook below. The table below provides exemplary representative amounts in ppm of the specific compounds in the noted food types. Non-limiting lower end amounts are reflected as well as non-limiting higher amounts where available. These are non-limiting compounds contemplated by the presently disclosed subject matter.

TABLE 6
Exemplary Flavors

| | | Low | Low | High | High | Ref |
|---|---|---|---|---|---|---|
| Odorant | CAS# | range | (food) | range | (food) | page |
| 2,3-butanedione | 431-03-8 | 0.76 ppm | snack | 62.18 ppm | fat/oil | 153 |
| | | | foods | | | |
| ethyl-2- | 97-62-1 | 5.2 ppm | meat | 100 ppm | soft | 241 |
| methylpropanoate | | | products | | candy | |
| ethyl butanoate | 105-54-4 | 18.6 ppm | meat | 1393 ppm | chewing | 221 |
| | | | products | | gum | |
| ethyl-2- | 7452-79-1 | 8.18 ppm | alcoholic | 500 ppm | chewing | 248 |
| methybutanoate | | | beverages | | gum | |
| ethyl-3- | 108-64-5 | 0.022 ppm | breakfast | 100 ppm | soft | 243 |
| methylbutanoate | | | cereals | | candy/ | |
| | | | | | jam, jelly | |
| hexanal | 66-25-1 | 1.3 ppm | nonalcoholic | 4.2 ppm | baked | 328 |
| | | | beverages | | goods | |
| propyl butanoate | 105-66-8 | 15 ppm | alcoholic | 74.39 ppm | frozen | 692 |
| | | | beverages | | dairy | |
| (E)-3-hexenal | | | | | | |
| (Z)-3-hexenal | 6789-80-6 | 1 ppm | alcoholic | 6.71 ppm | baked | 333 |
| | | | beverages | | goods | |
| myrcene | 123-35-3 | 5 ppm | alcoholic | 126 ppm | chewing | 585 |
| | | | beverages | | gum | |
| ethyl hexanoate | 123-66-0 | 0.2 ppm | meat | 170.1 ppm | hard | 235 |
| | | | products | | candy | |
| β-(Z)-ocimene | | | | | | |
| β-(E)-ocimene | | | | | | |
| 1-octen-3-one | 4312-99-6 | 1 ppm | meat, meat | 2 ppm | baked | 619 |
| | | | sauces, | | goods | |
| | | | soups | | | |
| 2-acetyl-1- | 99583-29-6 | NA | NA | NA | NA | NA |
| pyrroline | | | | | | |
| 1,5 (Z)-octadien- | 65767-22-8 | NA | NA | NA | NA | NA |
| 3-one | | | | | | |
| dimethyl | 3658-80-8 | 1 ppm | baked goods, | 1 ppm | condiment, | 196 |
| trisulfide | | | meat | | relish, | |
| | | | products | | soups, | |
| | | | | | gravies | |
| 4-mercapto-4- | 19872-52-7 | NA | NA | NA | NA | NA |
| methyl-2- | | | | | | |
| pentanone | | | | | | |
| 1-(E,Z)- | 16356-11-9 | 0.1 ppm | nonalcoholic | 5 ppm | chewing | 784 |
| undecatriene | | | beverages, | | gum, | |
| | | | instant | | household | |
| | | | coffee, tea | | seasonings | |
| acetic acid | 64-19-7 | 0.05 ppm | frozen dairy | 135.7 ppm | condiment, | 6 |
| | | | | | relish | |
| 2-isopropyl 3- | 25773-40-4 | NA | NA | NA | NA | NA |
| methoxy pyrazine | | | | | | |
| ethyl octanoate | 106-32-1 | 0.1 ppm | meat | 14.24 ppm | baked | 259 |
| | | | products | | goods | |
| 1,3,5,9- | 38533-54-9 | NA | NA | NA | NA | NA |
| undecatetraene | | | | | | |
| 3-(methylthio)- | 3268-49-3 | 0.1 ppm | fats, oils | 11.98 ppm | gravies | 576 |
| propanal | | | | | | |
| (Z)-3-hexenyl | 16491-36-4 | 0.25 ppm | chewing | 15 ppm | soft | 340 |
| butanoate | | | gum | | candy, | |
| | | | | | hard | |
| | | | | | candy | |
| 2,3-diethyl-5 | 18138-04-0 | 0.1 ppm | soups, | 1 ppm | baked | 159 |
| methyl pyrazine | | | nonalcoholic | | goods, | |
| | | | beverages | | breakfast | |
| | | | | | cereals | |
| decanal | 112-31-2 | 3.68 ppm | hard | 42.78 ppm | baked | 145 |
| | | | candy | | goods | |
| 2-nonenal | 60784-31-8 | 0.5 ppm | condiment, | 3.51 ppm | meat | 603 |
| (MIXTURE) | | | relish | | products | |
| (E)-2-nonenal | | | | | | |
| linalool | 78-70-6 | 0.42 ppm | alcoholic | 61 ppm | chewing | 431 |
| | | | beverages | | gum | |
| 4-methoxy-2,5- | 4077-47-8 | NA | NA | NA | NA | NA |
| dimethyl-3(2H)- | | | | | | |
| furanone | | | | | | |
| (E,Z)-2,6- | 557-48-2 | 0.1 ppm | condiment, | 0.1 ppm | frozen | 595 |
| nonadienal | | | relish | | dairy, | |
| | | | | | soft | |
| | | | | | candy | |
| butanoic acid | 107-62-6 | 3.54 ppm | alcoholic | 200 ppm | condiment, | 98 |
| | | | beverages | | relish | |
| 2-acetylthiazole | 24295-03-2 | 0.5 ppm | soups | 3 ppm | snack | 16 |
| | | | | | foods | |
| phenylacetaldehyde | 122-78-1 | 1.05 ppm | alcoholic | 6.09 ppm | chewing | 657 |
| | | | beverages | | gum | |
| 2- and 3- | 503-74-2 | 1.2 ppm | nonalcoholic | 14 ppm | frozen | 424 |
| methylbutanoic | | | beverages | | dairy | |
| acid | | | | | | |
| 3-methyl-2,4- | 113486-29-6 | NA | NA | NA | NA | NA |
| nonandione | | | | | | |
| 2-acetyl-2- | 29926-41-8 | NA | NA | NA | NA | NA |
| thiazoline | | | | | | |
| (E,Z)-2,6- | 28069-72-9 | 0.01 ppm | gravies | 1.04 ppm | soft | 597 |
| nonadienol | | | | | candy | |
| phenylethyl | 103-45-7 | 0.16 ppm | hard | 22.31 ppm | baked | 645 |
| acetate | | | candy | | goods | |
| (E)-β- | 23726-93-4 | NA | NA | NA | NA | NA |
| damascenone | | | | | | |
| dihydro-β-ionone | 17283-81-7 | 0.5 ppm | nonalcoholic | 10 ppm | chewing | 166 |
| | | | beverages | | gum | |
| 2-methoxyphenol | 90-05-1 | 0.01 ppm | chewing | 6.31 ppm | meat | 308 |
| | | | gum | | products | |
| phenylethyl | 60-12-8 | 0.1 ppm | fats, oils | 78.78 ppm | chewing | 645 |
| alcohol | | | | | gum | |
| γ-octalactone | 104-50-7 | 1 ppm | alcoholic | 21.39 ppm | gelatin, | 609 |
| | | | beverages | | pudding | |
| β-ionone | 79-77-6 | 0.4 ppm | alcoholic | 275.4 ppm | chewing | 373 |
| | | | beverages | | gum | |
| 4-hydroxy-2,5- | 3658-77-3 | 0.5 ppm | fats, oils | 10.49 ppm | frozen | 363 |
| dimethyl-3(2H)- | | | | | dairy | |
| furanone | | | | | | |
| γ-decalactone | 706-14-9 | 0.3 ppm | chewing | 28.58 ppm | baked | 144 |
| | | | gum | | goods | |
| δ-decalactone | 705-86-2 | 0.13 ppm | sweet sauce | 37.06 ppm | frozen | 144 |
| | | | | | dairy | |
| 3-hydroxy-4,5- | 28664-35-9 | 10 ppm | baked goods, | 10 ppm | baked goods, | 181 |
| dimethyl-2(5H)- | | | meat products, | | meat products, | |
| furanone | | | soups, gravies, | | soups, gravies, | |
| | | | condiment, | | condiment, | |
| | | | relish, fats, | | relish, fats, | |
| | | | oils, poultry | | oils, poultry | |
| | | | products, | | products, | |
| | | | fish products, | | fish products, | |
| | | | and sweet | | and sweet | |
| | | | sauces | | sauces | |
| 4-hydroxy-3- | 121-33-5 | 2.72 ppm | meat | 768.2 ppm | confectionery, | 792 |
| methoxy- | | | products | | frosting | |
| benzaldehyde | | | | | | |

### C. Mango Flavor Blends

The presently disclosed subject matter has created a base mango flavor composition that is common to a range of mango cultivars, with specific cultivar components that can be added to the base flavor to create the flavor for the desired cultivar. The base flavor can also be used on its own as a basic mango flavor or for blends that require a background mango note.

For both the base and cultivar flavor blends, some components are primary while others are secondary, tertiary, etc. Primary compounds contribute most to the flavor system character while secondary, tertiary, etc. components contribute less. Because individual flavor compounds have varying potencies, the amount needed in the flavor blend will vary. Thus, the amount of an individual compound can be determined by considering its predominance and its potency. When a compound is a primary compound and thus provides a larger contribution to the character of the flavor blend, the amount of the primary compound will increase when its potency is lower and will decrease when its potency is higher. These contribution and potency adjustments maintain the flavor system's balance.

In one embodiment of the presently disclosed subject matter, the base mango flavor includes a furanone compound, an ester compound, an aldehyde compound, a hydrocarbon compound, and a lactone compound. Each of the compounds has an ordered rank of predominance, whereby certain of the compounds are more prominent. The rank order by predominance is shown below, where the predominance reduces left to right.

Furanone>Lactone>Ester>Aldehyde>Hydrocarbon

The amount of each of the compounds in the base composition will depend on their relative potency. If the compound has a higher potency, a lower amount will be used in the base composition. Likewise, if the compound has a lower potency, a higher amount will be used in the base composition.

For example, if the compound has a higher potency, this is understood to mean that the potency is at least about one order of magnitude higher than a standard potency, and the use level of the compound in the base flavor composition is a certain percentage less than that of a compound having a standard potency. If the compound has the highest potency, that is at least about two orders of magnitude higher than a standard potency, and the use level of the compound in the base flavor composition is a certain percentage less than that of a compound having a standard potency.

Likewise, if the compound has a lower potency, this is understood to mean that the potency is at least about one order of magnitude lower than a standard potency, and the use level of the compound in the base flavor composition is a certain percentage more than that of a compound having a standard potency. If the compound has the lowest potency, that is at least about two orders of magnitude lower than a standard potency, and the use level of the compound in the base flavor composition is a certain percentage more than that of a compound having a standard potency.

One possible standard for measurement is the percentage range by weight of each component. When the weight percent is utilized as the proxy for potency, relative amounts of the compounds can be calculated. For example, see the Table below for a non-limiting example of calculations for preparing a base composition. In this Table, the ranges are provided for each of the compounds. Depending on the targeted potency for each compound, the weight percent is multiplied by the appropriate potency indicator. The various ranges are then computed across the potency indicators to provide for ranges of use in the base flavor composition.

TABLE 7
Base flavor blends

| | Furanone | Lactone | Ester | Aldehyde | Hydrocarbon |
|---|---|---|---|---|---|
| Percentage | 0.6-0.8 | 0.1-0.2 | 0.02-0.04 | 0.02-0.04 | 0.01-0.02 |
| range by | | | | | |
| weight | | | | | |
| Highest | 0.006-0.008 | 0.001-0.002 | 0.0002-0.0004 | 0.0002-0.0004 | 0.0001-0.0002 |
| potency | | | | | |
| 0.01 × % | | | | | |
| w/w | | | | | |
| Higher | 0.06-0.08 | 0.01-0.02 | 0.002-0.004 | 0.002-0.004 | 0.001-0.002 |
| potency | | | | | |
| 0.1 × % w/w | | | | | |
| Standard | 0.6-0.8 | 0.1-0.2 | 0.02-0.04 | 0.02-0.04 | 0.01-0.02 |
| potency | | | | | |
| 1.0 × % w/w | | | | | |
| Lower | 6-8 | 1-2 | 0.2-0.4 | 0.2-0.4 | 0.1-0.2 |
| potency | | | | | |
| 10 × % w/w | | | | | |
| Lowest | 60-80 | 10-20 | 2-4 | 2-4 | 1-2 |
| potency | | | | | |
| 100 × % w/w | | | | | |

Additional measurements can be used as a proxy for potency, whereby similar calculations can be configured to prepare a base blend. For example, threshold levels can be used to determine a reference point for potency. For example, threshold levels include detection levels, where a taste is detected in comparison to a control, for example water. Threshold levels also include recognition levels whereby a taste is specifically recognized, which is generally a higher level than a mere detection level. The threshold levels achieve an equivalent organoleptic effect whereby a specific target is either detectable or recognized.

By way of example, the following table provides representative threshold levels in ppb for both detection and recognition levels.

TABLE 8

| | odorant | | | recognition | |
|---|---|---|---|---|---|
| | class | odorant | odor quality | (ppb) | detection (ppb) |
| Base | furanone | 3-hydroxy-4,5- | maple | 1.1 | 0.49 |
| Flavor | group | dimethyl- | | | |
| | | 2(5H)- | | | |
| | | furanone | | | |
| | ester group | ethyl-2- | fruity | 0.063 | 0.013 |
| | | methybutanoate | | | |
| | aldehyde | (E,Z)-2,6- | cucumber | 0.0091 | 0.0045 |
| | group | nonadienal | | | |
| | hydrocarbon | 1-(E,Z)-3,5- | pineapple | 0.003 | NA |
| | group | undecatriene | | | |
| | lactone | γ-octalactone | coconut | 24 | 6.5 |
| | group | | | | |
| Cultivars | fruity | ethyl-2- | fruity | 0.063 | 0.013 |
| (Flavor | mango | methybutanoate | | | |
| Modifiers) | terpene-like | myrcene | terpene- | 4.9 | 1.2 |
| | mango | | like | | |
| | dairy-like | 3- | sweaty, | 1200 | 490 |
| | mango | methylbutanoic | rancid | | |
| | | acid | | | |
| | berry-like | β-ionone | violet-like | 8.4 | 3.5 |
| | mango | | | | |
| | tropical-like | 4-mercapto-4- | black | 0.0001 | NA |
| | mango | methyl-2- | current | | |
| | | pentanone | | | |

The specific odorant listed has been categorized one of the highest potency odorants within the noted class. As such, the highest potency relates to the littlest amount to be used in the composition. Therefore, relative potencies are then computed by orders of magnitude as detailed in the above Table. Additional threshold levels are discussed below in Example 4.

### D. Carriers, Matrices, Diluents, Additives and Additional Ingredients

Various carriers, matrices, diluents, additives and additional ingredients can be used depending on the specific flavor delivery system contemplated. For liquid systems, if the system is aqueous, solvents include but not limited to ethanol or propylene glycol. Where the liquid system is fat-based, the solvents are fat soluble solvents including but not limited to benzyl alcohol, triacetin, triethyl citrate, or vegetable oil.

For solid delivery systems, sugar or sugar derivatives can be used. Particular examples of suitable materials include but are not limited to sucrose, glucose, lactose, levulose, fructose, maltose, ribose, dextrose, isomalt, sorbitol, mannitol, xylitol, lactitol, maltitol, pentatol, arabinose, pentose, xylose, galactose, hydrogenated starch hydrolysates, maltodextrin, Stabilite (SPI Polyols, USA), agar, carrageenan, other gums, polydextrose and derivatives and mixtures thereof. In particular embodiments, carbohydrates such as sucrose are maltodextrin are used.

### III. AEDA Methodology

The presently disclosed subject matter was developed in part by analytical analyses on regional mangos performed to avoid overlooking any key compounds that can greatly influence the natural flavorings. To overcome the lack of distinct cultivar flavors available for true-fruit mango tastes, the presently disclosed subject matter has created a flavor system using aroma extract dilution analysis (AEDA) on fresh fruit from various mango cultivars. In addition, sensory experiments with the flavor compositions of the formulas given together with omission experiments were used to determine the relative importance of some of the components in the manufactured flavorings. A Flavor Dilution (FD)-chromatogram of the odorants was obtained for the odorants perceived in aroma extracts of various mango samples. FD-factors reflect the highest dilution at which a substance is still smelled and these are typically determined by AEDA.

AEDA is known as a powerful screening method used for the detection of aroma compounds, which combines a quantitative gas chromatography olfactometry (GCO) procedure for determining the potency of odorants in food. Using FD values from the AEDA tests, a base flavor system using compounds found in all the cultivars was created. Next, cultivars were characterized by their differences and cultivar components were designed by combining compounds identified as contributing to the distinct differences. The base and cultivar flavors were confirmed by creating a flavor system and testing the flavor system in a model confectionery product.

The AEDA technique is disclosed in Kelsk et al., J. AgirC Food Chem, 52:5155-5161 (2004) and in Grosch, Chem. Senses, 26:533-545 (2001), the disclosures of which are herein incorporated by reference in their entireties. The AEDA technique involves extraction of volatile compounds, gas chromatography olfactometry analysis (GC/O), and GC-MS analysis. The process is described in further detail below.

Chemical aroma standards are obtained for the target aroma. For mango standards, the specific regional fruit is the starting material for the AEDA analysis. Nonlimiting examples of tree ripened mango (Mangifera indica L.) varieties include Haden, White Alfonso, Praya Sowoy, Royal Special, and Malindi.

Volatile compounds are extracted from the fruit samples. For example, compounds are extracted with diethyl ether and an aroma isolate was prepared via high vacuum distillation. The aroma isolate was then serially diluted to a range of dilutions from 2 to 1,024. The various dilutions are then analyzed by GCO.

The FD factor data depict the highest dilution at which an odorant is still detectable by GCO. FD factors are relative measurements. The measurement is the ratio of the initial concentration to its most dilute extraction. Such measurements are proportional to a compounds odor activity value (OAV), which is the ratio of the concentration to an odor threshold in the air.

### IV. Delivery Systems

The flavoring compositions can be employed in liquid form, dried form, and/or solid form. When used in dried form, suitable drying means such as spray drying can be used. Alternatively, a flavoring composition can be encapsulated or absorbed onto water soluble materials, including but not limited to materials such as cellulose, starch, sugar, maltodextrin, gum arabic and so forth. The actual techniques for preparing such dried forms are well-known in the art, and can be applied to the presently disclosed subject matter.

The flavoring compositions of the presently disclosed subject matter can be used in many distinct physical forms well known in the art to provide an initial burst of flavor and/or a prolonged sensation of flavor. Without being limited thereto, such physical forms include free forms, such as spray dried, powdered, and beaded forms, and encapsulated forms, and mixtures thereof.

In specific embodiments, as noted above, encapsulation techniques can be used to modify the flavor systems. In certain embodiments, flavor compounds, flavor components, or the entire flavor system can be fully or partially encapsulated. Encapsulating materials and/or techniques can be selected to determine the type of modification of the flavor system.

In specific embodiments, the encapsulating materials and/or techniques are selected to improve the stability of the flavor compounds, flavor components, or flavor systems; while in other embodiments the encapsulating materials and/or techniques are selected to modify the release profile of the flavor compounds, flavor components, or flavor systems.

Suitable encapsulating materials can include, but are not limited to, hydrocolloids such as alginates, pectins, agars, guar gums, celluloses, and the like, proteins, polyvinyl acetate, polyethylene, crosslinked polyvinyl pyrrolidone, polymethylmethacrylate, polylactidacid, polyhydroxyalkanoates, ethylcellulose, polyvinyl acetatephthalate, polyethylene glycol esters, methacrylicacid-co-methylmethacrylate, ethylene-vinylacetate (EVA) copolymer, and the like, and combinations thereof. Suitable encapsulating techniques can include, but are not limited to, spray coating, spray drying, spray chilling, absorption, adsorption, inclusion complexing (e.g., creating a flavor/cyclodextrin complex), coacervation, fluidized bed coating, or other process can be used to encapsulate an ingredient with an encapsulating material.

Encapsulated delivery systems for flavoring agents or sweetening agents contain a hydrophobic matrix of fat or wax surrounding a sweetening agent or flavoring agent core. The fats can be selected from any number of conventional materials such as fatty acids, glycerides or poly glycerol esters, sorbitol esters, and mixtures thereof. Examples of fatty acids include but are not limited to hydrogenated and partially hydrogenated vegetable oils such as palm oil, palm kernel oil, peanut oil, rapeseed oil, rice bran oil, soybean oil, cottonseed oil, sunflower oil, safflower oil, and mixtures thereof. Examples of glycerides include but are not limited to monoglycerides, diglycerides, and triglycerides.

Waxes useful can be chosen from the group consisting of natural and synthetic waxes, and mixtures thereof. Non-limiting examples include paraffin wax, petrolatum, carbowax, microcrystalline wax, beeswax, carnauba wax, candellila wax, lanolin, bayberry wax, sugarcane wax, spermaceti wax, rice bran wax, and mixtures thereof.

The fats and waxes can be use individually or in combination in amounts varying from about 10 to about 70%, and alternatively in amounts from about 30 to about 60%, by weight of the encapsulated system. When used in combination, the fat and wax are preferably present in a ratio from about 70:10 to 85:15, respectively.

Typical encapsulated flavoring agent or sweetening agent delivery systems are disclosed in U.S. Pat. Nos. 4,597,970 and 4,722,845, the disclosures of which are incorporated herein by reference in their entireties.

### V. End Product Systems

The flavoring compositions of the present disclosed subject matter can be used in a wide variety of ingestible vehicles. Non-limiting examples of suitable ingestible vehicles include chewing gum compositions, hard and soft confections, dairy products, beverage products including juice products and soft drinks, pharmaceuticals, bakery goods, and frozen foods. The combination of the flavoring composition of the presently disclosed subject matter together with an ingestible vehicle and optional ingredients, when desired, provides a flavoring agent that possesses unexpected flavor value and imparts a unique note to a wide variety of flavors, especially tropical flavors such as mango flavor.

In the method for flavoring an ingestible composition of the presently disclosed subject matter, the ingestible composition is prepared by admixing the flavoring agent in an ingestible vehicle, together with any optional ingredients, to form a uniform mixture. The final compositions are readily prepared using standard methods and apparatus generally known by those skilled in the corresponding arts, such as confectionery arts. The apparatus useful in accordance with the presently disclosed subject matter comprises mixing apparatus well known in the art, and therefore the selection of the specific apparatus will be apparent to the artisan.

### A. Chewing Gum

The flavor systems can be used in sugarless gum formulations and can also be used in a sugar chewing gum. The flavor systems can be used in either regular chewing gum or bubble gum. Various specifics of chewing gum compositions are disclosed in U.S. Pat. No. 6,899,911, the disclosure of which is incorporated herein by reference in its entirety.

The chewing gum composition of the presently disclosed subject matter follows the general pattern outlined below. In general, a chewing gum composition typically contain a chewable gum base portion which is essentially free of water and is water-insoluble, a water-soluble bulk portion and flavors which are typically water insoluble. The water-soluble portion dissipates with a portion of the flavor over a period of time during chewing. The gum base portion is retained in the mouth throughout the chew.

The insoluble gum base generally comprises elastomers, elastomer solvents, plasticizers, waxes, emulsifiers and inorganic fillers. Plastic polymers, such as polyvinyl acetate, which behave somewhat as plasticizers, are also often included. Other plastic polymers that can be used include polyvinyl laureate, polyvinyl alcohol and polyvinyl pyrrolidone.

Elastomers can include polyisobutylene, butyl rubber, (isobutylene-isoprene copolymer) and styrene butadiene rubber, as well as natural latexes such as chicle. Elastomer solvents are often resins such as terpene resins. Plasticizers, sometimes called softeners, are typically fats and oils, including tallow, hydrogenated and partially hydrogenated vegetable oils, and cocoa butter. Commonly employed waxes include paraffin, microcrystalline and natural waxes such as beeswax and carnauba. Microcrystalline waxes, especially those with a high degree of crystallinity, can be considered bodying agents or textural modifiers.

According to the preferred embodiment of the presently disclosed subject matter, the insoluble gum base constitutes between about 5% to about 95% by weight of the gum. More preferably the insoluble gum base comprises between 10% and 50% by weight of the gum and most preferably about 20% to 35% by weight of the gum.

The gum base typically also includes a filler component. The filler component can be calcium carbonate, magnesium carbonate, talc, dicalcium phosphate or the like. The filler can constitute between about 5% and about 60% by weight of the gum base. Preferably the filler comprises about 5% to 50% by weight of the gum base.

Gum bases typically also contain softeners including glycerol monostearate and glycerol triacetate. Gum bases can also contain optional ingredients such as antioxidants, colors, and emulsifiers. The presently disclosed subject matter contemplates employing any commercially acceptable gum base.

The water-soluble portion of the chewing gum can further comprise softeners, sweeteners, flavors, physiological cooling agents and combinations thereof. The sweeteners often fulfill the role of bulking agents in the gum. The bulking agents typically comprise about 5% to about 95% of the gum composition.

Softeners are added to the chewing gum in order to optimize the chewability and mouth feel of the gum. Softeners, also known in the art as plasticizers or plasticizing agents, generally constitute between about 0.5% to about 15% of the chewing gum. Softeners contemplated by the presently disclosed subject matter include glycerin, lecithin and combinations thereof. Further, aqueous sweetener solutions such as those containing sorbitol, hydrogenated starch hydrolysate, corn syrup and combinations thereof can be used as softeners and binding agents in gum.

As mentioned above, the flavor systems of the presently disclosed subject matter can be used in sugarless gum formulations. However, formulations containing sugar are also within the scope of the invention. Sugar sweeteners generally include saccharide-containing components commonly known in the chewing gum art which comprise, but are not limited to, sucrose, dextrose, maltose, dextrin, dried invert sugar, fructose, galactose, corn syrup solids and the like, alone or in any combination.

The flavor systems of the presently disclosed subject matter can also be used in combination with sugarless sweeteners. Generally sugarless sweeteners include components with sweetening characteristics but which are devoid of the commonly known sugars and comprise, but are not limited to, sugar alcohols such as sorbitol, hydrogenated isomaltulose, mannitol, xylitol, lactitol, erythritol, hydrogenated starch hydrolysate, maltitol and the like alone or in any combination

Depending on the particular sweetness release profile and shelf-stability needed, coated or uncoated high-intensity sweeteners can be used in the chewing gum composition, or can be used in a coating applied to centers made from those gum compositions. High-intensity sweeteners, preferably aspartame, can be used at levels from about 0.01% to about 3.0%. Encapsulated aspartame is a high intensity sweetener with improved stability and release characteristics, as compared to free aspartame. Free aspartame can also be added, and a combination of some free and encapsulated aspartame is preferred when aspartame is used. Other high intensity sweeteners that can be used in the gum center are: saccharin, Thaumatin, alitame, saccharin salts, sucralose, Stevia, and acesulfame K. Overall, the chewing gum composition will preferable comprise about 0.5% to about 90% sweetening agents. Most typically the sweetening agents will comprises at least one bulk sweetener and at least one high-intensity sweetener.

Optional ingredients such as colors, emulsifiers and pharmaceutical agents can also be added as separate components of the chewing gum composition, or added as part of the gum base.

Aqueous syrups, such as corn syrup and hydrogenated corn syrup can be used, particularly if their moisture content is reduced. This can preferably be done by coevaporating the aqueous syrup with a plasticizer, such as glycerin or propylene glycol, to a moisture content of less than 10%. Preferred compositions include hydrogenated starch hydrolysate solids and glycerin. Such syrups and their methods of preparation are discussed in detail in U.S. Pat. No. 4,671,967.

A preferred method of manufacturing chewing gum according to the presently disclosed subject matter is by sequentially adding the various chewing gum ingredients to any commercially available mixer known in the art. After the ingredients have been thoroughly mixed, the gum is discharged from the mixer and shaped into the desired form such as by rolling into sheets and cutting into sticks, extruding into chunks, or casting into pellets.

Generally, the ingredients are mixed by first melting the gum base and adding it to the running mixer. The base can also be melted in the mixer itself. Color or emulsifiers can also be added at this time, along with syrup and a portion of the bulking agent. Further portions of the bulking agent can then be added to the mixer. Flavor systems are typically added with the final portion of the bulking agent. If the flavor system is coated or otherwise modified as when incorporated into a delivery system to modify its release rate, it will preferably be added after the final portion of bulking agent has been added. The entire mixing procedure typically takes from five to twenty minutes, but longer mixing times can sometime be required. Those skilled in the art will recognize that many variations of the above described procedures can be followed.

If formed into pellets or balls, the chewing gum composition can be coated. The coating is initially present as a liquid syrup which contains from about 30% to about 80% or 85% sugars or sugar alcohols, and from about 15% or 20% to about 70% of a solvent such as water. In general, the coating process is carried out in conventional panning equipment. Gum center tablets to be coated are placed into the panning equipment to form a moving mass.

The material or syrup which will eventually form the coating is applied or distributed over the gum center tablets. The flavor systems of the presently disclosed subject matter can be added before, during and after applying the syrup to the gum centers. Once the coating has dried to form a hard surface, additional syrup additions can be made to produce a plurality of coatings or multiple layers of coating. The flavor systems can be added to any or none of the coatings and/or layers.

In the panning procedure, syrup is added to the gum center tablets at a temperature range of from about 100° F. to about 240° F. Preferably, the syrup temperature is from about 140° F. to about 200° F. Most preferably, the syrup temperature should be kept constant throughout the process in order to prevent the polyol in the syrup from crystallizing. The syrup can be mixed with, sprayed upon, poured over, or added to the gum center tablets in any way known to those skilled in the art.

In another embodiment, a soft coating is formed by adding a powder coating after a liquid coating. The powder coating can include natural carbohydrate gum hydrolysates, maltodextrin, gelatin, cellulose derivatives, starches, modified starches, sugars, sugar alcohols, natural carbohydrate gums and fillers like talc and calcium carbonate.

Each component of the coating on the gum center can be applied in a single layer or in a plurality of layers. In general, a plurality of layers is obtained by applying single coats, allowing the layers to dry, and then repeating the process. The amount of solids added by each coating step depends chiefly on the concentration of the coating syrup. Any number of coats can be applied to the gum center tablet. Preferably, no more than about 75 coats are applied to the gum center. More preferably, less than about 60 coats are applied and most preferably, about 30 to about 60 coats are applied. In any event, the presently disclosed subject matter contemplates applying an amount of syrup sufficient to yield a coated chewing gum product containing about 10% to about 65% coating. Preferably, the final product will contain from about 20% to about 50% coating.

Those skilled in the art will recognize that in order to obtain a plurality of coated layers, a plurality of premeasured aliquots of coating syrup can be applied to the gum center. It is contemplated, however, that the volume of aliquots of syrup applied to the gum center can vary throughout the coating procedure.

Once a coating of syrup is applied to the gum center, the syrup is dried in an inert medium. A preferred drying medium comprises air. Preferably, forced drying air contacts the wet syrup coating in a temperature range of from about 70° F. to about 110° F. More preferably, the drying air is in the temperature range of from about 80° F. to about 100° F. The invention also contemplates that the drying air possesses a relative humidity of less than about 15 percent. Preferably, the relative humidity of the drying air is less than about 8%.

The drying air can be passed over and admixed with the syrup coated gum centers in any way commonly known in the art. Preferably, the drying air is blown over and around the syrup coated gum center at a flow rate, for large scale operations, of about 2800 cubic feet per minute. If lower quantities of material are being processed, or if smaller equipment is used, lower flow rates would be used. If a flavor is applied after a syrup coating has been dried, the presently disclosed subject matter contemplates drying the flavor with or without the use of a drying medium.

The amount of flavoring agent employed herein is normally a matter of preference subject to such factors as the type of final chewing gum composition, the individual flavor, the gum base employed, and the strength of flavor desired. Thus, the amount of flavoring can be varied in order to obtain the result desired in the final product and such variations are within the capabilities of those skilled in the art without the need for undue experimentation. In gum compositions, the flavoring agent is generally present in amounts from about 0.02% to about 5%, and preferably from about 0.1% to about 2%, and more preferably, from about 0.8% to about 1.8%, by weight of the chewing gum composition.

### B. Sugar Confectionery

Another important aspect of the presently disclosed subject matter includes a confectionery composition incorporating the inventive flavoring agent and a method for preparing the confectionery compositions. The preparation of confectionery formulations is well-known in the art. Confectionery items have been classified as either “hard” confectionery or “soft” confectionery. The flavoring agents of the presently disclosed subject matter can be incorporated into the confections by admixing the compositions of the presently disclosed subject matter into the conventional hard and soft confections.

Hard confectionery can be processed and formulated by conventional means. In general, a hard confectionery has a base composed of a mixture of sugar and other carbohydrate bulking agents kept in an amorphous or glassy condition. The hard confectionery can also be sugarless. This form is considered a solid syrup of sugars generally having from about 0.5% to about 1.5% moisture. Such materials normally contain up to about 92% sugar, up to about 55% corn syrup and from about 0.1% to about 5% water, by weight of the final composition. The syrup component is generally prepared from sucrose and corn syrups, but can include other materials. Further ingredients such as flavorings, sweetening agents, acidulants, colorants and so forth can also be added.

Such confectionery can be routinely prepared by conventional methods, including but not limited to methods involving fire cookers, vacuum cookers, and scraped-surface cookers also referred to as high speed atmospheric cookers. The apparatus useful in accordance with the presently disclosed subject matter comprises cooking and mixing apparatus well known in the confectionery manufacturing arts, and therefore the selection of the specific apparatus will be apparent to the artisan.

Fire cookers involve the traditional method of making a candy base. In this method, the desired quantity of carbohydrate bulking agent is dissolved in water by heating the agent in a kettle until the bulking agent dissolves. Additional bulking agent can then be added and cooked until a final temperature of 145° C. to 156° C. is achieved. The batch is then cooled and worked as a plastic-like mass to incorporate additives such as flavoring agent, colorants and the like.

A high-speed atmospheric cooker uses a heat-exchanger surface, which involves spreading a film of candy on a heat exchange surface, the candy is heated to 165° C. to 170° C. within a few seconds. The candy is then rapidly cooled to 100° C. to 120° C. and worked as a plastic-like mass enabling incorporation of the additives, such as flavoring agent, colorants and the like. In vacuum cookers, the carbohydrate bulking agent is boiled to 125° C. to 132° C., vacuum is applied and additional water is boiled off without extra heating. When cooking is complete, the mass is a semi-solid and has a plastic-like consistency. At this point, flavoring agent, colorants, and other additives are admixed in the mass by routine mechanical mixing operations.

The optimum mixing required to uniformly mix the flavoring agent, colorants and other additives during conventional manufacturing of hard confectionery is determined by the time needed to obtain a uniform distribution of the materials. Generally, mixing times of from 2 to 10 minutes have been found to be acceptable.

Once the candy mass has been properly tempered, it can be cut into workable portions or formed into desired shapes. A variety of forming techniques can be utilized depending upon the shape and size of the final product desired. A general discussion of the composition and preparation of hard confections can be found in H. A. Lieberman, Pharmaceutical Dosage Forms: Tablets, Volume 1 (1989), Marcel Dekker, Inc., New York, N.Y. at pages 419 to 582, which disclosure is incorporated herein by reference.

Compressed tablet confections contain particular materials and are formed into structures under pressure. These confections generally contain sugars in amounts up to about 95%, by weight of the composition, and typical tablet excipients such as binders and lubricants as well as flavoring agent, colorants and so forth. These confections can also be sugarless.

Similar to hard confectionery, soft confectionery can be utilized in the embodiments of the disclosed subject matter. The preparation of soft confections, such as nougat, involves conventional methods, such as the combination of two primary components, namely (1) a high boiling syrup such as a corn syrup, or the like, and (2) a relatively light textured frappe, generally prepared from egg albumin, gum arabic, gelatin, vegetable proteins, such as soy derived compounds, sugarless milk derived compounds such as milk proteins, and mixtures thereof. The frappe is generally relatively light, and can, for example, range in density from about 0.5 to about 0.7 grams/cc.

The high boiling syrup, or “bob syrup” of the soft confectionery is relatively viscous and has a higher density than the frappe component, and frequently contains a substantial amount of carbohydrate bulking agent. Conventionally, the final nougat composition is prepared by the addition of the “bob syrup” to the frappe under agitation, to form the basic nougat mixture. Further ingredients such as flavoring, additional carbohydrate bulking agent, colorants, preservatives, medicaments, mixtures thereof and the like can be added thereafter also under agitation. Soft confectioneries can also be prepared sugarless. A general discussion of the composition and preparation of nougat confections can be found in B. W. Minifie, Chocolate, Cocoa and Confectionery: Science and Technology, 2nd edition, AVI Publishing Co., Inc., Westport, Conn. (1983), at pages 576-580, which disclosure is incorporated herein by reference.

In general, the frappe component is prepared first and thereafter the syrup component is slowly added under agitation at a temperature of at least about 65° C., and preferably at least about 100° C. The mixture of components is continued to be mixed to form a uniform mixture, after which the mixture is cooled to a temperature below 80° C., at which point, the flavor can be added. The mixture is further mixed for an additional period until it is ready to be removed and formed into suitable confectionery shapes.

In accordance with this invention, effective amounts of the flavoring agents of the presently disclosed subject matter can be admixed into the hard and soft confections. The exact amount of flavoring agent employed is normally a matter of preference subject to such factors as the particular type of confection being prepared, the type of bulking agent or carrier employed, the type of flavor employed and the intensity of breath freshening perception desired. Thus, the amount of flavoring agent can be varied in order to obtain the result desired in the final product and such variations are within the capabilities of those skilled in the art without the need for undue experimentation. In general, the amount of flavoring agent normally present in a hard or soft confection will be from about 0.001% to about 20%, preferably from about 0.01% to about 15%, more preferably from about 0.01% to about 10%, and more preferably from about 0.01% to about 5%, and more preferably 0.01% to about 0.5% by weight of the confection.

The presently disclosed subject matter extends to methods for making the improved confections. The flavoring agents can be incorporated into an otherwise conventional hard or soft confection composition using standard techniques and equipment known to those skilled in the art. The apparatus useful in accordance with the presently disclosed subject matter comprises mixing and heating apparatus well known in the confectionery manufacturing arts, and therefore the selection of the specific apparatus will be apparent to the artisan.

In such a method, a composition is made by admixing the inventive flavoring agent into the confectionery composition along with the other ingredients of the final desired composition. Other ingredients will usually be incorporated into the composition as dictated by the nature of the desired composition as well known by those having ordinary skill in the art. The ultimate confectionery compositions are readily prepared using methods generally known in the food technology and pharmaceutical arts. Thereafter the confectionery mixture can be formed into desirable confectionery shapes.

The flavoring agents can be formulated with conventional ingredients which offer a variety of textures to suit particular applications. Such ingredients can be in the form of hard and soft confections, tablets, toffee, nougat, chewy candy, chewing gum and so forth, center filled candies, both sugar and sugarless. The acceptable ingredients can be selected from a wide range of materials. Without being limited thereto, such materials include diluents, binders and adhesives, lubricants, disintegrants, bulking agents, humectants and buffers and adsorbents. The preparation of such confections and chewing gum products is well known.

### C. Pharmaceuticals

The flavoring compositions can also be in the form of a pharmaceutical. One nonlimiting example of a pharmaceutical form is a suspension. Pharmaceutical suspensions can be prepared by conventional compounding methods. Suspensions can contain adjunct materials employed in formulating the suspensions of the art. The suspensions of the presently disclosed subject matter can comprise preservatives, buffers, suspending agents, antifoaming agents, sweetening agents, flavoring agents, coloring or decoloring agents, solubilizers, and combinations thereof.

Flavoring agents such as those flavors well known to the skilled artisan, such as natural and artificial flavors and mints, such as peppermint, menthol, citrus flavors such as orange and lemon, artificial vanilla, cinnamon, various fruit flavors, both individual and mixed and the like can be utilized in amounts from about 0.01% to about 5%, and more preferably 0.01% to about 0.5% by weight of the suspension.

The pharmaceutical suspensions of the presently disclosed subject matter can be prepared as follows.
(A) admix the thickener with water heated from about 40° C. to about 95° C., preferably from about 40° C. to about 70° C., to form a dispersion if the thickener is not water soluble or a solution if the thickener is water soluble;
(B) admix the sweetening agent with water to form a solution;
(C) admix the flavoring agent with the thickener-water admixture to form a uniform thickener-flavoring agent;
(D) combine the sweetener solution with the thickener-flavoring agent and mix until uniform; and
(E) admix the optional adjunct materials such as coloring agents, flavoring agents, decolorants, solubilizers, antifoaming agents, buffers and additional water with the mixture of step (D) to form the suspension.

The flavoring compositions can also be in chewable form. To achieve acceptable stability and quality as well as good taste and mouth feel in a chewable formulation several considerations are important. These considerations include the amount of active substance per tablet, the flavoring agent employed, the degree of compressibility of the tablet and additional properties of the composition.

Chewable pharmaceutical candy is prepared by procedures similar to those used to make soft confectionery. A general discussion of the lozenge and chewable tablet forms of confectionery can be found in H. A. Lieberman and L. Lachman, Pharmaceutical Dosage Forms: Tablets Volume 1, Marcel Dekker, InC, New York, N.Y. (1989) at pages 367 to 418, which disclosure is incorporated herein by reference. In a typical procedure, a boiled sugar-corn syrup blend is formed to which is added a frappe mixture. The boiled sugar-corn syrup blend can be prepared from sugar and corn syrup blended in parts by weight ratio of about 90:10 to about 10:90. The sugar-corn syrup blend is heated to temperatures above about 120° C. to remove water and to form a molten mass. The frappe is generally prepared from gelatin, egg albumin, milk proteins such as casein, and vegetable proteins such as soy protein, and the like, which is added to a gelatin solution and rapidly mixed at ambient temperature to form an aerated sponge like mass. The frappe is then added to the molten candy mass and mixed until homogeneous at temperatures between about 65° C. and about 120° C. The flavor composition can then be added to the homogeneous mixture as the temperature is lowered to about 65° C.-95° C. whereupon additional ingredients can then be added such as flavoring agents and coloring agents. The formulation is further cooled and formed into pieces of desired dimensions.

In other pharmaceutical embodiments, the flavoring agent is incorporated into an ingestible topical vehicle which can be in the form of a mouthwash, rinse, ingestible spray, suspension, dental gel, and the like. Typical non-toxic ingestible vehicles known in the pharmaceutical arts can be used in the presently disclosed subject matter. The preferred ingestible vehicles are water, ethanol, and water-ethanol mixtures. The water-ethanol mixtures are generally employed in a weight ratio from about 1:1 to about 20:1, preferably from about 3:1 to about 20:1, and most preferably from about 3:1 to about 10:1, respectively. The pH value of the ingestible vehicle is generally from about 4 to about 7, and preferably from about 5 to about 6.5. An ingestible topical vehicle having a pH value below about 4 is generally irritating to the ingestible cavity and an ingestible vehicle having a pH value greater than about 7 generally results in an unpleasant mouth feel.

The ingestible topical flavoring agents can also contain conventional additives normally employed in those products. Conventional additives include a fluorine providing compound, a sweetening agent, a flavoring agent, a coloring agent, a humectant, a buffer, and an emulsifier, providing the additives do not interfere with the flavoring properties of the composition. The coloring agents and humectants, and the amounts of these additives to be employed, set out above, can be used in the ingestible topical composition.

The flavoring agents (flavors, flavorants) which can be used include those flavors known to the skilled artisan, such as natural and artificial flavors. Suitable flavoring agents include mints, such as peppermint, citrus flavors such as orange and lemon, artificial vanilla, cinnamon, various fruit flavors, both individual and mixed, and the like.

The amount of flavoring agent employed in the ingestible topical composition is normally a matter of preference subject to such factors as the type of final ingestible composition, the individual flavor employed, and the strength of flavor desired. Thus, the amount of flavoring can be varied in order to obtain the result desired in the final product and such variations are within the capabilities of those skilled in the art without the need for undue experimentation. The flavoring agents, when used, are generally utilized in amounts that can, for example, range in amounts from about 0.05% to about 6%, by weight of the ingestible topical composition.

In accordance with the presently disclosed subject matter, effective amounts of the flavoring agents of the presently disclosed subject matter can be admixed with an ingestible topical vehicle to form a topical composition. These amounts are readily determined by those skilled in the art without the need for undue experimentation. In a preferred embodiment, the ingestible topical flavoring agents will comprise the flavoring agent in an amount from about 0.025% to about 2% and an ingestible topical vehicle in a quantity sufficient to bring the total amount of composition to 100%, by weight of the ingestible topical composition. In a more preferred embodiment, the ingestible topical flavoring agents will comprise the flavoring agent in an amount from about 0.05% to about 1% and an ingestible topical vehicle in a quantity sufficient to bring the total amount of composition to 100%, by weight of the ingestible topical composition.

The presently disclosed subject matter extends to methods for preparing the ingestible topical flavoring agents. In such a method, the ingestible topical composition is prepared by admixing an effective amount of the flavoring agent of the presently disclosed subject matter and an ingestible topical vehicle. The final compositions are readily prepared using standard methods and apparatus generally known by those skilled in the pharmaceutical arts. The apparatus useful in accordance with the presently disclosed subject matter comprises mixing apparatus well known in the pharmaceutical arts, and therefore the selection of the specific apparatus will be apparent to the artisan.

### D. Chocolates and Fillings

The presently disclosed subject matter is also used with and/or in chocolate products, chocolate-flavored confections, and chocolate flavored compositions. Chocolates also include those containing crumb solids or solids fully or partially made by a crumb process. Various chocolates are disclosed, for example, in U.S. Pat. Nos. 7,968,140 and 8,263,168, the disclosures of which are incorporated herein by reference in their entireties. A general discussion of the composition and preparation of chocolate confections can be found in B. W. Minifie, Chocolate, Cocoa and Confectionery: Science and Technology, 2nd edition, AVI Publishing Co., Inc., Westport, Conn. (1982), which disclosure is incorporated herein by reference.

The term “chocolate” as used herein refers to a solid or semi-plastic food and is intended to refer to all chocolate or chocolate-like compositions containing a fat-based component phase or fat-like composition. The term is intended to include standardized or nonstandardized compositions conforming to the U.S. Standards Of Identity (SOI), CODEX Alimentarius and/or other international standards and compositions not conforming to the U.S. Standards Of Identity or other international standards. The term includes dark chocolate, baking chocolate, sweet chocolate, bittersweet or semisweet chocolate, milk chocolate, buttermilk chocolate, skim milk chocolate, mixed dairy product chocolate, white chocolate, sweet cocoa and vegetable fat coating, sweet chocolate and vegetable fat coating, milk chocolate and vegetable fat coating, vegetable fat based coating, pastels including white chocolate or coating made with cocoa butter or vegetable fat or a combination of these, nutritionally modified chocolate-like compositions (chocolates or coatings made with reduced calorie ingredients) and low fat chocolates, aerated chocolates, compound coatings, non-standardized chocolates and chocolate-like compositions, unless specifically identified otherwise.

Nonstandardized chocolates result when, for example, the nutritive carbohydrate sweetener is replaced partially or completely; or when the cocoa butter, cocoa butter alternative, cocoa butter equivalent, cocoa butter extender, cocoa butter replacer, cocoa butter substitute or milkfat are replaced partially or completely; or when components that have flavors that imitate milk, butter or chocolate are added or other additions or deletions in formula are made outside the FDA standards of identify of chocolate or combinations thereof. Chocolate-like compositions are those fat-based compositions that can be used as substitutes for chocolate in applications such as panning, molding, or enrobing; for example, carob.

In the United States, chocolate is subject to a standard of identity established by the U.S. Food and Drug Administration (FDA) under the Federal Food, Drug and Cosmetic Act. Definitions and standards for the various types of chocolate are well established in the U.S. Nonstandardized chocolates are those chocolates which have compositions that fall outside the specified ranges of the standardized chocolates.

The chocolate can contain a sugar syrup/solids, invert sugar, hydrolyzed lactose, maple sugar, brown sugar, molasses, honey, sugar substitute and the like. The term “sugar substitute” includes bulking agents, sugar alcohols (polyols such as glycerol), or high potency sweeteners or combinations thereof. Nutritive carbohydrate sweeteners with varying degrees of sweetness intensity can be any of those typically used in the art and include, but are not limited to, sucrose, e.g. from cane or beet, dextrose, fructose, lactose, maltose, glucose syrup solids, corn syrup solids, invert sugar, hydrolyzed lactose, honey, maple sugar, brown sugar, molasses and the like. Sugar substitutes can partially replace the nutritive carbohydrate sweetener. High potency sweeteners include aspartame, cyclamates, saccharin, acesulfame-K, neohesperidin dihydrochalcone, sucralose, alitame, stevia sweeteners, glycyrrhizin, thaumatin and the like and mixtures thereof. The preferred high potency sweeteners are aspartame, cyclamates, saccharin, and acesulfame-K. Examples of sugar alcohols can be any of those typically used in the art and include sorbitol, mannitol, xylitol, maltitol, isomalt, lactitol and the like.

The chocolates can also contain bulking agents. The term “bulking agents” as defined herein can be any of those typically used in the art and include polydextrose, cellulose and its derivatives, maltodextrin, gum arabic, and the like.

The chocolate products can contain emulsifiers. Examples of safe and suitable emulsifiers can be any of those typically used in the art and include lecithin derived from vegetable sources such as soybean, safflower, corn, etc., fractionated lecithins enriched in either phosphatidyl choline or phosphatidyl ethanolamine, or both, mono- and digylcerides, diacetyl tartaric acid esters of mono- and diglycerides (also referred to as DATEM), monosodium phosphate derivatives of mono- and diglycerides of edible fats or oils, sorbitan monostearate, hydroxylated lecithin, lactylated fatty acid esters of glycerol and propylene glycol, polyglycerol esters of fatty acids, propylene glycol mono- and di-esters of fats and fatty acids, or emulsifiers that can become approved for the US FDA-defined soft candy category. In addition, other emulsifiers that can be used include polyglycerol polyricinoleate (PGPR), ammonium salts of phosphatidic acid, (e.g. YN) sucrose esters, oat extract, etc., any emulsifier found to be suitable in chocolate or similar fat/solid system or any blend.

The term “chocolate-flavored confection” refers to food products, excluding “chocolate”, having a chocolate flavor/aroma and comprising a cocoa fraction. These products are stable at ambient temperatures for extended periods of time (e.g., greater than 1 week) and are characterized as microbiologically shelf-stable at 18-30° C. under normal atmospheric conditions. Examples include chocolate-flavored hard candies, chewables, chewing gums, etc.

The term “chocolate-flavored compositions” refers to chocolate-flavored compositions, excluding “chocolate”, containing a cocoa fraction and having a chocolate flavor/aroma. Examples include chocolate-flavored cake mixes, ice creams, syrups, baking goods, etc. The term includes chocolate-flavored compositions (e.g., cakes, nougats, puddings, etc.), as well as compositions not having a chocolate-flavor (e.g., caramels, etc.).

### E. Food Products

The presently disclosed subject matter can be used in a variety of food products. The term “food product” includes any food product, for example, those set forth in 21 CFR 101.12. Nonlimiting examples of such food products include frozen desserts, baked goods, fillings, nutritional drinks, beverages, salad dressing or similar dressing, sauces, icings, puddings and custards, batters, and the like. Various baked goods are disclosed in U.S. Pat. No. 6,536,599, the disclosure of which is herein incorporated by reference in its entirety. Non-limiting examples of bakery goods includes cookies, cakes, rolls, pastries, pie dough, brownies, breads, bagels and the like. The flavor compositions are also suitable as a component in frozen foods.

### EXAMPLES

The presently disclosed subject matter will be better understood by reference to the following Examples, which are provided as exemplary of the invention, and not by way of limitation.

### Example 1

### Evaluation of Fruity Mango Flavor

The present example has evaluated the FD factors of specific mango cultivars through AEDA techniques.

### Methodology

Mango Fruits.

Fresh tree ripened mango (Mangifera indica L.) varieties, namely, Haden (H), White Alfonso (WA), Praya Sowoy (PS), Royal Special (RS), and Malindi (M), were obtained. from the USDA ARS Station in Miami, Fla. All analysis was conducted upon arrival of the fruit.

Reference Aroma Compounds.

All of the aroma compounds were purchased from the commercial vendors. or synthesized as described in the literature. (Buttery, R. G.; Ling, L. C.; Juliano, B. O.; Turnbaugh, J. G., Cooked rice aroma and 2-acetyl-1-pyrroline. J. Agric. Food Chem. 1983, 31, 823-826; Ullrich, F.; Grosch, W., Identification of the most intense odor compounds formed during autoxidation of methyl linolenate at room temperature Journal of the American Oil Chemists' Society 1988, 65, 1313-1317; Steinhaus, M.; Sinuco, D.; Polster, J.; Osorio, C.; Schieberle, P., Characterization of the aroma-active compounds in pink guava (Psidium guajava, L.) by application of the aroma extract dilution analysis. Journal of agricultural and food chemistry 2008, 56, 4120-4127.)

Preparation of the Aroma Isolates.

Fresh ripe mangos were peeled, the seed was removed, and the flesh was cut into small 4 cm³ sections. The sections were immediately frozen in liquid nitrogen, ground into a fine powder with a laboratory mill and sequentially extracted with freshly distilled diethyl ether (1×100 mL; 1×50 mL) on an autoshaker at room temperature for 10 minutes. After centrifugation (5000 rpm for 5 minutes), the supernatants were combined and the residue was discarded. The organic layer was then separated in a separatory funnel and the aqueous layer was discarded. The ether extract (total volume: 150 mL) was then subjected to high-vacuum distillation using the SAFE technique (Engel, W.; Bahr, W.; Schieberle, P., Solvent assisted flavour evaporation—a new and versatile technique for the careful and direct isolation of aroma compounds from complex food matrices. European Food Research and Technology 1999, 209, 237-241.). The distillation apparatus was thermostated at 40° C. and kept under high vacuum (10-5 mbar). The sample was dropped into the extraction flask of the apparatus over 40 minutes, after which the extraction was continued for an additional 30 minutes. At the completion of the extraction time, the vacuum was broken and the collection flask was removed. The sample was thawed at room temperature and dried over anhydrous sodium sulfate. The sample was then concentrated to approximately 2 ml using a Vigreux column (50×1 cm) held at 50° C. and finally concentrated (total volume: 200 uL) under a gentle stream of nitrogen. The aroma quality of the isolate was then evaluated to ensure that it closely matched the odor quality of the fresh ripe mango flesh.

Gas Chromatography-Olfactometry—(GC-O).

An Agilent 6890 series GC system was used for GC-O analysis. DB-5 and HP-FFAP (each 30 m×0.32 mm, 0.25 μm film thickness) capillaries were used for the chromatographic separations. The samples were injected on-column at 35° C. using helium as the carrier gas. The flow rate set to 1.0 mL/min. The effluent was split 1:1 by volume at the end of the capillary by a Y-type splitter into two sections of deactivated fused silica capillaries. One section was directed to the flame ionization detector (FID) held at 250° C., and the other part to a heated sniffing-port held at 180° C. The sniffing port was mounted on the front FID detector base and consisted of a custom machined aluminum cylindrical cone (80 mm×25 mm i.d.) housing the capillary. During the GC-O analysis, the odor of the effluent from the sniffing-port was evaluated by a panelist and as an odor was detected the retention time and the odor quality were recorded.

Aroma Extract Dilution Analysis (AEDA).

SAFE isolates were diluted to obtain serial dilutions of 1:1, 1:2, 1:4, 1:8, . . . 1:2048 of the stock aroma isolate solutions (Schieberle, P., Recent developments in methods for analysis of flavor compounds and their precursors. In Characterization of Food: Emerging Methods Goankar, A., Ed. Elsevier Amsterdam, The Netherlands, 1995; pp 403-431). The following 6 dilutions (1:4, 1:8, 1:32, 1:128, 1:512, and 1:2048) were analyzed by GC-O using a capillary FFAP column, using the conditions as described above. The aroma-active regions were identified in the chromatograms and each aroma detected was assigned an FD factor corresponding to the highest dilution in which the aroma was detectable.

Silica Gel Fractionation of the Mango Aroma Isolate.

SAFE isolates, prepared as described above, were concentrated to 1 mL with use of a Vigreux column and applied to silica gel solid phase extraction (SPE) cartridge (Phenomenex, Torrance, Calif.) that was conditioned sequentially with pentane/diethyl ether/pentane (5 mL each). Elution was performed with pentane/diethyl ether (5 mL; 1:0; v/v; Fraction A) followed by pentane/diethyl ether (5 mL, 98:2; v/v; Fraction B), pentane/diethyl ether (5 mL; 95:5; v/v; Fraction C), pentane/diethyl ether (5 mL; 9:1; v/v; Fraction D), pentane/diethyl ether (5 mL; 1:1; v/v; Fraction E) and finally pentane/diethyl ether (5 mL; 0:1; v/v; Fraction F). Each fraction was then concentrated on Vigreux column (total volume: 2 mL) held at 50° C. and finally concentrated to 200 uL under a gentle stream of nitrogen prior to analysis. The odorants detected during AEDA were identified in the fractions by GC-O and mass spectra were recorded by GC-MS.

Gas Chromatography-Mass Spectrometry (GC-MS).

Mass spectra were recorded on an Agilent 6890 series GC system coupled to an Agilent 5973 mass spectrometer detector. A capillary column HP-FFAP (30 m×0.25 mm, 0.25 μm film thickness) was used for the chromatographic separation. The temperature program was follows: 35° C. for 1 min, then increased at 60° C./min to 60° C., then increased at 6° C./min to 230° C., and held for 10 min. The samples were injected on-column at 35° C. using helium as the carrier gas with a constant flow of 1 ml/min. MS parameters were as follows: operated in electron impact (EI) ionization mode at 70 eV; scan range, m/z 50-550 for identification experiments; and the transfer line was maintained at 250° C.

Aroma Profile Determination.

Fresh mango samples (15 g) were cut into cubes (2 cm³) and placed into 20 mL borosilicate glass scintillation vials (Thermo Fisher Scientific, Fairlawn, N.J.) and each sample was orthonasally evaluated by a trained sensory panel (12 panelists). The descriptors used for the evaluations were determined in preliminary experiments. Each descriptor used was defined on the basis of the odor of a reference compound dissolved in water at a concentration of 100 times above the respective threshold value or using a standard reference material. Reference odorants used in the sensory experiments were ethyl butanoate (fruity), 4-hydroxy-2,5-dimethyl-3(2H)-furanone (caramel, sweet), butanoic acid (sweaty), linalool (floral, citrus), (Z)-3-hexenal (green), myrcene (terpene-like), (R/S)-γ-octalactone (coconut) and 4-mercapto-4-methyl-2-pentanone (tropical, sulfurous). The standard sensory reference materials used in the study were fresh pineapple cubes (2 cm³) (pineapple) and fresh raspberries (raspberry). Panelists rated the descriptor for each of the samples on a seven-point scale in 0.5 increments from 0 to 3, with 0=not detectable, 1=weak, 2=moderate, and 3=strong.

### Results and Discussion

### Fruity Sensorial Attributes

The evaluation resulted in a mango flavor reminiscent of a mango cultivar with higher fruity sensorial attributes. The specific odorants included the following compounds.

TABLE 9

| | |
|---|---|
| Group 1 | ethyl-2-methypropanoate, ethyl butanoate, ethyl-2- |
| | methybutanoate, and/or ethyl-3-methylbutanoate |
| Group 2 | 2-acetyl-1-pyrroline, 1-(E,Z)-undecatriene, 3-(methylthio)- |
| | propanal, 2-phenylethyl alcohol, γ-octalactone, |
| | δ-octalactone |

In certain nonlimiting embodiments, the Group 1 listed compounds are more preferred, whereas the Group 2 compounds are preferred. The following Table summarizes the data obtained.

TABLE 10

| | odor | RI on FD factor | | |
|---|---|---|---|---|
| odorant | quality | FFAP | DB-5 | H |
| ethyl-2-methypropanoate | fruity | 950 | 750 | 512 |
| ethyl butanoate | fruity | 1015 | 802 | 2048 |
| ethyl-2-methybutanoate | fruity | 1020 | 851 | 512 |
| ethyl-3-methylbutanoate | fruity | 1055 | 850 | 2048 |
| 2-acetyl-1-pyrroline | cooked | 1350 | 920 | 512 |
| | rice | | | |
| 1-(E,Z)-3,5-undecatriene | pineapple | 1400 | 1170 | 512 |
| 3-(methylthio)-propanal | cooked | 1450 | 902 | 512 |
| | potato | | | |
| 2-phenylethanol | floral, | 1901 | 1117 | 128 |
| | rose | | | |
| γ-octalactone | coconut | 1910 | 1260 | 512 |
| δ-octalactone | coconut | 1963 | 1289 | 512 |
| 4-hydroxy-2,5-dimethyl-3(2H)- | caramel- | 2015 | 1080 | 2048 |
| furanone | like | | | |

### Terpene-Like Sensorial Attributes

The evaluation resulted in a mango flavor reminiscent of a regional mango cultivar with higher terpene-like sensorial attributes. The specific odorants included the following compounds.

TABLE 11

| | |
|---|---|
| Group 1 | myrcene, β-(Z)-ocimene, and or β-(E)-ocimene |
| Group 2 | ethyl butanoate, 2-acetyl-1-pyrroline, 1-(E,Z)-undecatriene, |
| | 1,3,5,8-undecatetraene, γ-octalactone, |
| | β-ionone, β-octalactone |

The following Table summarizes the data obtained.

TABLE 12

| | odor | RI on FD factor | | |
|---|---|---|---|---|
| odorant | quality | FFAP | DB-5 | WA |
| ethyl butanoate | fruity | 1015 | 802 | 128 |
| myrcene | terpene- | 1155 | 990 | 128 |
| | like | | | |
| β-(Z)-ocimene | terpene- | 1250 | 1043 | 512 |
| | like | | | |
| β-(E)-ocimene | terpene- | 1270 | 1050 | 128 |
| | like | | | |
| 1-(E,Z)-3,5-undecatriene | pineapple | 1400 | 1170 | 512 |
| 1,3,5,8-undecatetraene | pineapple | 1435 | 1172 | 128 |
| 3-(methylthio)-propanal | cooked | 1450 | 902 | 32 |
| | potato | | | |
| γ-octalactone | coconut | 1910 | 1260 | 512 |
| β-ionone | violet- | 1930 | 1492 | 512 |
| | like | | | |
| δ-□octalactone | coconut | 1963 | 1289 | 128 |
| 4-hydroxy-2,5-dimethyl-3(2H)- | caramel- | 2015 | 1080 | 2048 |
| furanone | like | | | |
| 2-acetyl-1-pyrroline | | | | |

### Dairy-Like Sensorial Attributes

The evaluation resulted in a mango flavor reminiscent of a mango cultivar with higher dairy-like sensorial attributes. The specific odorants included the following compounds.

TABLE 13

| | |
|---|---|
| Group 1 | butanoic acid, 2- and 3-methylbutanoic acid, and |
| | 2,3 butanedione |
| Group 2 | ethyl butanoate, (E)-3-hexenal, 2-acetyl-1-pyrroline, (E)-2- |
| | nonenal, (E,Z)-2,6-nonadienal, 3-methyl-2,4-nonandione, |
| | γ-octalactone. |

The following Table summarizes the data obtained.

TABLE 14

| | odor | RI on FD factor | | |
|---|---|---|---|---|
| odorant | quality | FFAP | DB-5 | PS |
| 2,3-butandione | buttery | 985 | <600 | 32 |
| ethyl butanoate | fruity | 1015 | 802 | 128 |
| (E)-3-hexenal | green | 1130 | 800 | 512 |
| (Z)-3-hexenal | green | 1140 | 790 | 128 |
| 2-acetyl-1-pyrroline | cooked | 1350 | 920 | 128 |
| | rice | | | |
| (E)-2-nonenal | green | 1530 | 1161 | 128 |
| (E,Z)-2,6-nonadienal | cucumber | 1580 | 1150 | 128 |
| butanoic acid | sweaty, | 1610 | 820 | 128 |
| | rancid | | | |
| 2- and 3-methylbutanoic acid | sweaty, | 1660 | 885 | 128 |
| | rancid | | | |
| 3-methyl-2,4-nonandione | hay-like | 1715 | 1246 | 128 |
| γ-octalactone | coconut | 1910 | 1260 | 128 |
| 4-hydroxy-2,5-dimethyl-3(2H)- | caramel- | 2015 | 1080 | 2048 |
| furanone | like | | | |

### Berry-Like Sensorial Attributes

The evaluation resulted in a mango flavor reminiscent of a mango cultivar with higher berry-like sensorial attributes. The specific odorants included the following compounds.

TABLE 15

| | |
|---|---|
| Group 1 | dihydro-β-ionone and β-ionone |
| Group 2 | 1,3,5,8-undecatetraene, 1-(E,Z)-3,5-undecatriene, 4-methoxy- |
| | 2,5-dimethyl-3(2H)-furanone, γ-octalactone. |

The following Table summarizes the data obtained.

TABLE 16

| | odor | RI on FD factor | | |
|---|---|---|---|---|
| odorant | quality | FFAP | DB-5 | RS |
| ethyl butanoate | fruity | 1015 | 802 | 32 |
| 1,3,5,8-undecatetraene | pineapple | 1435 | 1172 | 512 |
| 2,3-diethyl-5 methyl pyrazine | earthy | 1495 | 1158 | 128 |
| 4-methoxy-2,5-dimethyl-3(2H)- | caramel- | 1578 | 1040 | 128 |
| furanone | like | | | |
| dihydro-β-ionone | violet- | 1825 | 1433 | 128 |
| | like | | | |
| γ-octalactone | coconut | 1910 | 1260 | 512 |
| β-ionone | violet- | 1930 | 1492 | 512 |
| | like | | | |
| 4-hydroxy-2,5-dimethyl-3(2H)- | caramel- | 2015 | 1080 | 2048 |
| furanone | like | | | |
| 1-(E,Z)-3,5-undecatriene | | | | |

### Tropical or Grapefruit-Like Sensorial Attributes

The evaluation resulted in a mango flavor reminiscent of a mango cultivar with higher tropical or grapefruit-like sensorial attributes. The specific odorants included the following compounds.

TABLE 17

| | |
|---|---|
| Group 1 | 1-p-menthene-8-thiol, 4-mercapto-4-methyl-2-pentanone |
| Group 2 | myrcene, 2-acetyl-1-pyrroline, 1-(E,Z)-3,5-undecatriene, |
| | γ-octalactone, and δ-octalactone |

The following Table summarizes the data obtained.

TABLE 18

| | odor | RI on FD factor | | |
|---|---|---|---|---|
| odorant | quality | FFAP | DB-5 | M |
| myrcene | terpene- | 1155 | 990 | 128 |
| | like | | | |
| 2-acetyl-1-pyrroline | cooked | 1350 | 920 | 512 |
| | rice | | | |
| 1,3,5,8-undecatetraene | pineapple | 1435 | 1172 | 512 |
| γ-octalactone | coconut | 1910 | 1260 | 512 |
| β-ionone | violet- | 1930 | 1492 | 32 |
| | like | | | |
| δ-□octalactone | coconut | 1963 | 1289 | 128 |
| 4-hydroxy-2,5-dimethyl-3(2H)- | caramel- | 2015 | 1080 | 2048 |
| furanone | like | | | |
| 1-p-menthene-8-thiol | | | | |
| 4-mercapto-4-methyl-2- | | | | |
| pentanone | | | | |
| 1-(E,Z)-3,5-undecatriene | | | | |

### Example 2

### Mango Flavor Composition

The present example provides a nonlimiting example of a composition for a mango flavor composition.

TABLE 19

| Odorant | ppm in flavor | ppb in final product |
|---|---|---|
| myrcene | 800 | 4000 |
| 4-hydroxy-2,5-dimethyl-3(2H)- | 39.14 | 195.7 |
| furanone | | |
| γ-decalactone | 25.45 | 127.25 |
| ethyl butanoate | 0.3 | 1.5 |
| (E,Z)-2,6-nonadienal | 0.285 | 1.425 |
| δ-decalactone | 12.382 | 61.91 |
| ethyl 2-methylpropanoate | 0.192 | 0.96 |
| linalool | 9.15 | 45.75 |
| γ-dodecalactone | 9.05 | 45.25 |
| hexanal | 7.3 | 36.5 |
| hexyl acetate | 5.7 | 28.5 |
| 1-octen-3-one | 0.11 | 0.55 |
| methyl 2-methylbutanoate | 4.76 | 23.8 |
| octanal | 0.076 | 0.38 |
| β-ionone | 3.08 | 15.4 |
| vanillin | 0.06 | 0.3 |
| β-damascenone | 0.035332 | 0.17666 |
| (Z)-3-hexenal | 1.98 | 9.9 |
| 1-(E,Z)-3,5-undecatriene | 0.036 | 0.18 |
| (E)-2-nonenal | 0.035 | 0.175 |
| geraniol | 1.76 | 8.8 |
| γ-octalactone | 1.682 | 8.41 |
| ethyl 2-methyl butanoate | 0.628 | 3.14 |
| methyl 2-methylpropanoate | 0.616 | 3.08 |

### Example 3

### Chewing Gum Compositions

The present example provides for formulations of various chewing gum compositions.

TABLE 20

| | A | B | C | D | E | F |
|---|---|---|---|---|---|---|
| Sugarless syrup* | 30-40 | | 30-40 | 30-40 | 30-40 | 30-40 |
| Sorbitol | 30-40 | | 30-40 | 30-40 | 30-40 | 30-40 |
| Corn Syrup | | 30-40 | | | | |
| Granulated Sugar | | 30-40 | | | | |
| Gum base | 20-30 | 20-30 | 20-30 | 20-30 | 20-30 | 20-30 |
| Base Flavor | 0.75-2.50 | 0.75-2.50 | 0.75-2.50 | 0.75-2.50 | 0.75-2.50 | 0.75-2.50 |
| H Cultivar Flavor | 0.15-1.15 | 0.15-1.15 | | | | |
| WA Cultivar Flavor | | | 0.15-1.15 | | | |
| PS Cultivar Flavor | | | | 0.15-1.15 | | |
| RS Cultivar Flavor | | | | | 0.15-1.15 | |
| M Cultivar Flavor | | | | | | 0.15-1.15 |
| Free high intensity | 0.05-0.5 | 0.05-0.5 | 0.05-0.5 | 0.05-0.5 | 0.05-0.5 | 0.05-0.5 |
| sweeteners | | | | | | |
| Glycerin | 0.5-2 | 0.5-2 | 0.5-2 | 0.5-2 | 0.5-2 | 0.5-2 |
| Color | 0.05-0.5 | 0.05-0.5 | 0.05-0.5 | 0.05-0.5 | 0.05-0.5 | 0.05-0.5 |
| Total | 100.00% | 100.00% | 100.00% | 100.00% | 100.00% | 100.00% |

*Coevaporated aqueous mixture of sorbitol, mannitol, maltitol, and glycerin.

The method of making chewing gums generally involves warming the gum base to a temperature of about 40 C following by incorporating of the sweeteners by mixing. Once the sweeteners are fully mixed, the glycerin can be mixed in with color and flavor added at the end. Once a homogeneous mixture is obtained, the chewing gum can be formed and then wrapped.

### Example 4

### Exemplary Threshold Levels

The following Example provides odor thresholds of weakest and strongest odorants with the different aroma groups, as well as alternative compounds for the first tier of odorants. These odorants are representative in defining the unique sensory attributes of the aroma isolates of the different cultivars.

In the following Table, bold-face entries were found to be the most potent, whereas the italicized entries were found to be the least potent.

TABLE 21

| Flavor | Group | odorants | odor quality | recog. ppb |
|---|---|---|---|---|
| Base | furanone | 4-methoxy-2,5-dimethyl-3(2H)- | caramel-like | 3400 |
| Flavor | group | furanone (mesifuran)^{a} | | |
| | | 4-hydroxy-2,5-dimethyl-3(2H)- | caramel-like | 160 |
| | | furanone (furaneol)^{b} | | |
| | | 3-hydroxy-4,5-dimethyl-2(5H)- | maple | 1.1 |
| | | furanone (sotolone)^{b} | | |
| | | maltol | | |
| | | ethyl maltol | | |
| | | 5-ethyl-3-hydroxy-2(5H)- | | |
| | | furanone (abhexon) | | |
| | | 4-hydroxy-5-methyl-3 (2H)- | | |
| | | furanone (norfuraneol) | | |
| | | 2-(5)-ethyl-4-hydroxy-5-(2)- | | |
| | | methyl-3 (2H)-furanone | | |
| | | (ethylfuraneol) | | |
| | ester group | ethyl-2-methypropanoate^{b} | fruity | 0.22 |
| | | ethyl butanoate^{b} | fruity | 2.4 |
| | | ethyl-2-methybutanoate^{b} | fruity | 0.063 |
| | | ethyl-3-methylbutanoate^{b} | fruity | 0.11 |
| | | methyl-2-methybutanoate | | |
| | | methyl-3-methylbutanoate | | |
| | | 2-methylbutanoate | | |
| | | 3-methylbutanoate | | |
| | | (Z)-3-hexeny butanoate | | |
| | aldehyde | (E)-3-hexenal^{c} | green | 160 |
| | group | (Z)-3-hexenal^{b} | green | 0.21 |
| | | (E)-2-nonenal^{c} | green | 0.4 |
| | | (E,Z)-2,6-nonadienal^{b} | cucumber | 0.0091 |
| | | (Z)-6-nonenal | | |
| | | (E)-2-hexenal | | |
| | | (E/Z)-2-hexenol (alcohol) | | |
| | | (E/Z)-3-hexenol (alcohol) | | |
| | | (E,Z)-2,6-nonadienol (alcohol) | | |
| | hydrocarbon | myrcene^{b} | terpene-like | 4.9 |
| | group | β-(Z)-ocimene^{c} | terpene-like | 34 |
| | | β-(E)-ocimene^{c} | terpene-like | 34 |
| | | 1-(E,Z)-3,5-undecatriene^{g} | pineapple | 0.003 |
| | | 1,3,5,8-undecatetraene | pineapple | |
| | | α or β-pinene | | |
| | | linalool oxide | | |
| | | α-terpinene | | |
| | | α-terpinolene | | |
| | | 1,3,5,9-undecatetraene | | |
| | | diphenyl ether | | |
| | lactone | γ-octalactone^{b} | coconut | 24 |
| | group | γ-decalactone^{b} | coconut | 2.6 |
| | | δ-decalactone^{b} | coconut | 51 |
| | | δ-octalactone | | |
| | | γ-nonalactone | | |
| | | δ-nonalacone | | |
| | | γ-dodecalactone | | |
| | | δ-dodecalactone | | |
| | | 5-butyl-4-methyldihydro-2(3H)- | | |
| | | furanone | | |
| Flavor | fruity | ethyl-2-methypropanoate^{b} | fruity | 0.22 |
| Modifiers | mango | ethyl butanoate^{b} | fruity | 2.4 |
| | | ethyl-2-methybutanoate^{b} | fruity | 0.063 |
| | | ethyl-3-methylbutanoate^{b} | fruity | 0.11 |
| | | acetyl-1-pyrroline | | |
| | | 1-(E,Z)-3,5-undecatriene | | |
| | | 3-(methylthio)-propanal | | |
| | | phenylethyl alcohol | | |
| | | γ-octalactone | | |
| | | δ-octalactone | | |
| | | methyl-2-methybutanoate | | |
| | | methyl-3-methylbutanoate | | |
| | | 2-methylbutanoate | | |
| | | 3-methylbutanoate | | |
| | | (Z)-3-hexenyl butanoate | | |
| | terpene-like | myrcene^{b} | terpene-like | 4.9 |
| | mango | β-(Z)-ocimene^{c} | terpene-like | 34 |
| | | β-(E)-ocimene^{c} | terpene-like | 34 |
| | | ethyl butanoate | | |
| | | 2-acetyl-1-pyrroline | | |
| | | 1-(E,Z)-undecatriene | | |
| | | 1,3,5,8-undecatetraene | | |
| | | γ-octalactone | | |
| | | β-ionone | | |
| | | δ-octalactone | | |
| | | α or β-pinene | | |
| | | linalool oxide | | |
| | | α-terpinene | | |
| | | α-terpinolene | | |
| | | 1,3,5,9-undecatetraene | | |
| | | diphenyl ether | | |
| | dairy-like | 3-methylbutanoic acid^{b} | sweaty, | 1200 |
| | mango | | rancid | |
| | | 2-methylbutanoic acid^{b} | sweaty, | 5800 |
| | | | rancid | |
| | | butanoic acid^{b} | sweaty, | 7700 |
| | | | rancid | |
| | | 2,3 butanedione^{b} | buttery | 2.9 |
| | | ethyl butanoate | | |
| | | (E)-3-hexenal | | |
| | | 2-acetyl-1-pyrroline | | |
| | | (E,Z)-2,6-nonadienal | | |
| | | (E)-2-nonenal | | |
| | | 3-methyl-2,4-nonandione | | |
| | | γ-octalactone | | |
| | | 2-methylpropanoic acid | | |
| | | 2 or 4-methyl pentanoic acid | | |
| | | pentanoic acid | | |
| | | 2,3-pentanedione | | |
| | | 3-hydroxybutanone | | |
| | berry-like | β-ionone^{b} | violet-like | 8.4 |
| | mango | dihydro-β-ionone^{e} | violet-like | 1.7 |
| | | 1,3,5,8-undecatetraene | | |
| | | 1-(E,Z)-3,5-undecatriene | | |
| | | 4-methoxy-2,5-dimethyl-3(2H)- | | |
| | | furanone | | |
| | | γ-octalactone | | |
| | | α-ionone | | |
| | | (E)-β-damascenone | | |
| | | α-damascone | | |
| | tropical-like | 4-mercapto-4-methyl-2- | blackcurrent | 0.0001 |
| | mango | pentanone^{a} | | |
| | | 1-p-menthene-8-thiol^{f} | grapefruit | 0.0001 |
| | | myrcene | | |
| | | 2-acetyl-1-pyrroline | | |
| | | 1-(E,Z)-3,5-undecatriene | | |
| | | γ-octalactone | | |
| | | δ-octalactone | | |
| | | 4-menthen-8-thiol-3-one | | |
| | | 4-methoxy-2-methylbutane-2- | | |
| | | thiol | | |
| | | 1-methoxy-3-methylbutane-3- | | |
| | | thiol | | |
| | | 3-thiohexyl butanonate | | |
| | | 3-thiohexyl hexanoate | | |

^{a}Belitz H-D, Grosch W, Schieberle P (2009) Food Chemistry 4th edition
^{b}Czerny, M. et al (2008) Eur Food Res Technol 228: 265-273 Re-investigation on odour thresholds of key food aroma compounds and development of an aroma language based on odour qualities of defined aqueous odorant solutions
^{c}Tamura H, Boonbumrun S, Yoshizawa T, Varanyanond W (2001) Food Sci. Technol. Res. 7(1) 72-77 The Volatile Constituents in the Peel and Pulp of a Green Thai Mango, Khieo Sawoei Cultivar (Mangifera indica L.)
^{d}Tokitomo Y, Steinhaus M, Buettner A, Schieberle P (2005) Biosci Biotechnol Biochem 69: 1323-1330. Odor-active constituents in fresh Pineapple (Ananas cosmosus [L.] Men.) by quantitative and sensory evaluation
^{e}Elisabetta Brenna, Claudio Fuganti, Stefano Serra, and Philip Kraft, Optically Active Ionones and Derivatives: Preparation and Olfactory Properties, Eur. J. Org. Chem. 2002, 967-978
^{f}Buettner, A.; Schieberle, P., Evaluation of key aroma compounds in hand-squeezed grapefruit juice (Citrus paradisi Macfayden) by quantitation and flavor reconstitution experiments. Journal of agricultural and food chemistry 2001, 49, 1358-1363. g Steinhaus, M.; Wilhelm, W.; Schieberle, P., Comparison of the most odour-active volatiles in different hop varieties by application of a comparative aroma extract dilution analysis. European Food Research and Technology 2006, 226, 45-55.

Although the presently disclosed subject matter and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, means, methods, or steps.

Patents, patent applications publications product descriptions, and protocols are cited throughout this application the disclosures of which are incorporated herein by reference in their entireties for all purposes.

1. A flavor composition comprising:
a. a furanone compound,
b. an ester compound,
c. an aldehyde compound,
d. a hydrocarbon compound, and
e. a lactone compound.

2. The flavor composition of claim 1, wherein the furanone compound is selected from the group consisting of 4-methoxy-2,5-dimethyl-3(2H)-furanone, 4-hydroxy-2,5-dimethyl-3(2H)-furanone, 3-hydroxy-4,5-dimethyl-2(5H)-furanone, and combinations thereof.

3. The flavor composition of claim 1, wherein the furanone compound is present at an amount of from about 0.6% to about 0.8% w/w, or from about 0.7% to about 0.8% w/w in the composition.

4. (canceled)

5. The flavor composition of claim 1, wherein the ester compound is selected from the group consisting of ethyl-2-methypropanote, ethyl butanoate, ethyl-2-methybutanoate, ethyl-3-methylbutanoate, and combinations thereof.

6. The flavor composition of claim 1, wherein the ester compound is present at an amount of from about 0.02% to about 0.04% w/w, or from about 0.03% to about 0.04% w/w in the composition.

7. (canceled)

8. The flavor composition of claim 1, wherein the aldehyde compound is selected from the group consisting of (E)-3-hexenal, (Z)-3-hexenal, (E)-2-nonenal, (E,Z)-2,6-nonadienal, and combinations thereof.

9. The flavor composition of claim 1, wherein the aldehyde compound is present at an amount of from about 0.02% to about 0.04% w/w, or from about 0.03% to about 0.04% w/w in the composition.

10. (canceled)

11. The flavor composition of claim 1, wherein the hydrocarbon compound is selected from the group consisting of myrcene, β-(Z)-ocimene, β-(E)-ocimene, 1-(E,Z)-undecatriene, 1,3,5,8-undecatetraene, and combinations thereof.

12. The flavor composition of claim 1, wherein the hydrocarbon compound is present at an amount of from about 0.01% to about 0.02% w/w, or from about 0.015% to about 0.02% w/w in the composition.

13. (canceled)

14. The flavor composition of claim 1, wherein the lactone compound is selected from the group consisting of γ-octalactone, γ-decalactone, δ-decalactone, and combinations thereof.

15. The flavor composition of claim 1, wherein the lactone compound is present at an amount of from about 0.01% to about 0.02% w/w, or from about 0.015% to about 0.02% w/w in the composition.

16. (canceled)

17. The flavor composition of claim 1, wherein the flavor composition is natural.

18. The flavor composition of claim 1, further comprising a cultivar component.

19. The flavor composition of claim 18, wherein the cultivar component is a fruity component.

20. (canceled)

21. The flavor composition of claim 19, wherein the fruity component comprises a compound is selected from the group consisting of ethyl-2-methypropanoate, ethyl butanoate, ethyl-2-methybutanoate, ethyl-3-methylbutanoate, 2-acetyl-1-pyrroline, 1-(E,Z)-undecatriene, 3-(methylthio)-propanal, phenylethyl alcohol, γ-octalactone, and combinations thereof.

22. (canceled)

23. The flavor composition of claim 18, wherein the cultivar component is a terpene-like component.

24. (canceled)

25. The flavor composition of claim 23, wherein the terpene-like component comprises a compound selected from the group consisting of myrcene, β-(Z)-ocimene, β-(E)-ocimene, ethyl butanoate, 2-acetyl-1-pyrroline, 1-(E,Z)-undecatrine, 1,3,5,8-undecatetraene, γ-octalactone, β-ionone, and combinations thereof.

26. (canceled)

27. The flavor composition of claim 18, wherein the cultivar component is a dairy component.

28. (canceled)

29. The flavor composition of claim 27, wherein the dairy component comprises a compound selected from the group consisting of 2,3-butandione, butanoic acid, 2-methylbutanoic acid, 3-methylbutanoic acid, ethyl butanoate, (E)-3-hexenal, 2-acetyl-1-pyrroline, (E)-2-nonenal, (E,Z)-2,6-nonedienal, 3-methyl-2,4-nonandione, γ-octalactone, and combinations thereof.

30. (canceled)

31. The flavor composition of claim 18, wherein the cultivar component is a berry component.

32. (canceled)

33. The flavor composition of claim 31, wherein the berry component comprises a compound is selected from the group consisting of dihydro-β-ionone, β-ionone, 1,3,5,8-undecatetraene, 4-methoxy-2,5-dimethyl-3(2H)-furanone, γ-octalactone, and combinations thereof.

34. (canceled)

35. The flavor composition of claim 18, wherein the cultivar component is a tropical component.

36. (canceled)

37. The flavor composition of claim 35, wherein the tropical component comprises a compound selected from the group consisting of 4-mentha-8-thiol-3-one, 4-mercapto-4-methyl-2-pentanone, myrcene, 2-acetyl-1-pyrroline, γ-octalactone, and combinations thereof.

38. (canceled)

39. A food product comprising the flavor composition of claim 1.

40-59. (canceled)

60. A method of making a cultivar mango flavor composition comprising:
(a) providing a base flavor composition;
(b) providing a cultivar component; and
(c) combining the base flavor composition with the cultivar component.

61-68. (canceled)
